(19) United States
(12) Patent Application Publication
(10) Pub. No.: US 2026/0289690 A1
(43) Pub. Date: Sep. 24, 2026

(54) SYSTEM

(71) Applicant: SoftBank Group Corp., Tokyo (JP)

(72) Inventor: Hiroyuki MIZUNO, Tokyo (JP)

(73) Assignee: SoftBank Group Corp., Tokyo (JP)

(21) Appl. No.: 19/567,382

(22) Filed: Mar. 16, 2026

(30) Foreign Application Priority Data
Mar. 19, 2025 (JP) 2025-045076

(51) Int. Cl. G06Q 40/12; G06F 40/284; G06N 3/084

(52) U.S. Cl. CPC G06Q 40/124; G06F 40/284; G06N 3/084

(57) ABSTRACT

A system includes a processor that is configured to confirm requirements for verifying a financial status of an organization or an enterprise based on performance data of the organization or the enterprise, use a generative AI model to automatically generate audit check items and to preliminarily confirm applicability of the audit check items, and use an emotion engine that recognizes an emotion of a user and provides advice according to the emotion of the user.

### CROSS-REFERENCE TO RELATED APPLICATION

This application is based on and claims priority under 35 USC 119 from Japanese Patent Application No. 2025-045076 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional internal audit support systems primarily focus on static rule-based checklists and manual preparation processes. As a result, such systems have multiple problems. First, they require substantial manual effort to analyze organizational performance data and to identify requirements for verifying a financial status. Second, they typically do not utilize generative AI models to dynamically generate audit check items and therefore lack flexibility and scalability when audit requirements or business conditions change. Third, they generally do not perform a preliminary applicability assessment of each audit check item based on current performance data, which leads to the inclusion of unnecessary or irrelevant audit procedures and increases the workload of users. Fourth, existing systems do not consider the emotional state of users, such as stress or anxiety associated with audit preparations, and thus cannot provide adaptive advice that supports users in a more human-centric manner. Accordingly, there is a need for a system that automatically identifies audit requirements from performance data, generates and updates audit check items with generative AI, evaluates their applicability in advance, prepares for audit responses in a timely way, and further recognizes user emotions to provide emotion-aware advice.

### SUMMARY

To solve the above-described problems, the invention provides a system comprising a processor. The processor is configured to confirm requirements for verifying a financial status of an organization or an enterprise based on performance data of the organization or the enterprise. The processor is further configured to use a generative AI model to automatically generate audit check items and to preliminarily confirm applicability of the audit check items, so that non-relevant or unnecessary audit items can be filtered out before audit execution. The processor is also configured to use an emotion engine that recognizes an emotion of a user and provides advice according to the emotion of the user, thereby enabling adaptive and empathetic guidance during audit preparation and execution. In some embodiments, the processor is configured to prepare for audit responses and wait until an appropriate timing for the audit responses, thereby organizing required documents and procedures in advance and maintaining audit readiness. In other embodiments, the processor is configured to use the generative AI model to update the audit check items and determine applicability of the updated audit check items in response to changes in regulations, internal policies, or performance conditions. By these means, the system can continuously maintain up-to-date, relevant, and user-sensitive audit support.

The term “system” refers to a combination of hardware and software components, including at least one processor and associated memory, storage, and communication interfaces, that cooperatively perform the functions described in the claims.

The term “processor” refers to one or more hardware processing units, such as a central processing unit (CPU), a graphics processing unit (GPU), a digital signal processor (DSP), an application-specific integrated circuit (ASIC), a field-programmable gate array (FPGA), or any combination thereof, capable of executing instructions to perform the claimed operations.

The term “organization or an enterprise” refers to any entity that conducts business or administrative activities, including but not limited to corporations, partnerships, governmental bodies, non-profit organizations, and other institutional entities.

The term “performance data” refers to data that represents operational or financial results of an organization or an enterprise, including but not limited to financial statements, transaction records, key performance indicators, management reports, and other quantitative or qualitative data used to evaluate business performance.

The term “financial status” refers to a state or condition of the finances of an organization or an enterprise, including but not limited to profitability, liquidity, solvency, asset and liability composition, and overall financial health as understood in the context of accounting and auditing.

The term “requirements for verifying a financial status” refers to conditions, rules, criteria, standards, or procedures that need to be satisfied or examined in order to confirm the correctness, completeness, and reliability of the financial status of an organization or an enterprise.

The term “generative AI model” refers to an artificial intelligence model, such as a neural network-based model, that is capable of generating text or other data outputs based on input data or prompts, including but not limited to large language models, transformer models, and other generative models.

The term “audit check items” refers to individual items, questions, procedures, or tests that are used in an audit process to verify compliance with accounting standards, regulations, internal policies, or other audit requirements.

The term “automatically generate audit check items” refers to the process in which the processor, without requiring manual creation of each item by the user, uses a generative AI model and associated logic to produce audit check items based on input data such as performance data and audit requirements.

The term “applicability” refers to a relevance or necessity of an audit check item with respect to a given audit context, performance data, or requirement, indicating whether the audit check item should be executed in an audit for a particular organization or period.

The term “preliminarily confirm applicability” refers to evaluating, before actual execution of an audit procedure, whether each generated audit check item is applicable to the current performance data or audit context, and determining an applicability status such as applicable or not applicable.

The term “emotion engine” refers to a component implemented by software and/or hardware that is configured to detect, infer, or classify a user's emotional state based on input signals, such as textual inputs, voice, facial expressions, behavioral patterns, or interaction history, and to generate corresponding outputs or actions.

The term “emotion of a user” refers to an affective or psychological state of a user, including but not limited to states such as stress, anxiety, confusion, confidence, satisfaction, or other emotional conditions.

The term “advice according to the emotion of the user” refers to guidance, recommendations, messages, or instructions that are adapted in content, tone, timing, or level of detail to the detected emotion of the user, so that support is tailored to the user's emotional state.

The term “prepare for audit responses” refers to actions performed by the processor to organize, plan, or coordinate activities required for responding to an audit, including but not limited to identifying necessary documents, scheduling tasks, assigning responsibilities, and generating checklists.

The term “wait until an appropriate timing for the audit responses” refers to maintaining a state of readiness for audit responses and triggering or prompting specific actions, notifications, or task executions when a predetermined time, event, or condition related to the audit is satisfied.

The term “update the audit check items” refers to modifying, adding, or deleting audit check items or their parameters in response to changes in underlying requirements, such as new regulations, revised accounting standards, updated internal policies, or changes in performance data.

The term “determine applicability of the updated audit check items” refers to evaluating, after updating audit check items, whether each updated item is relevant or necessary for a particular organization, period, or audit context, and setting an applicability status for each updated item.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

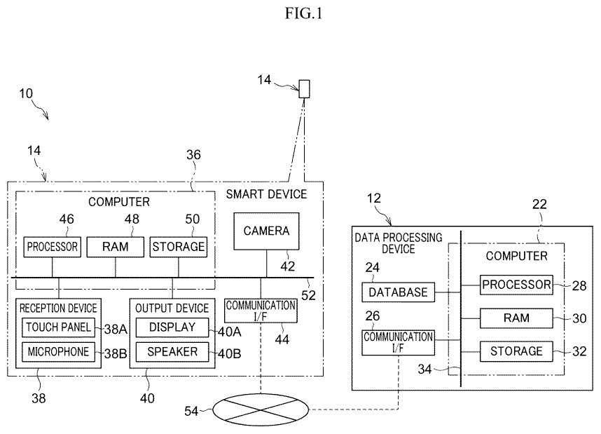

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

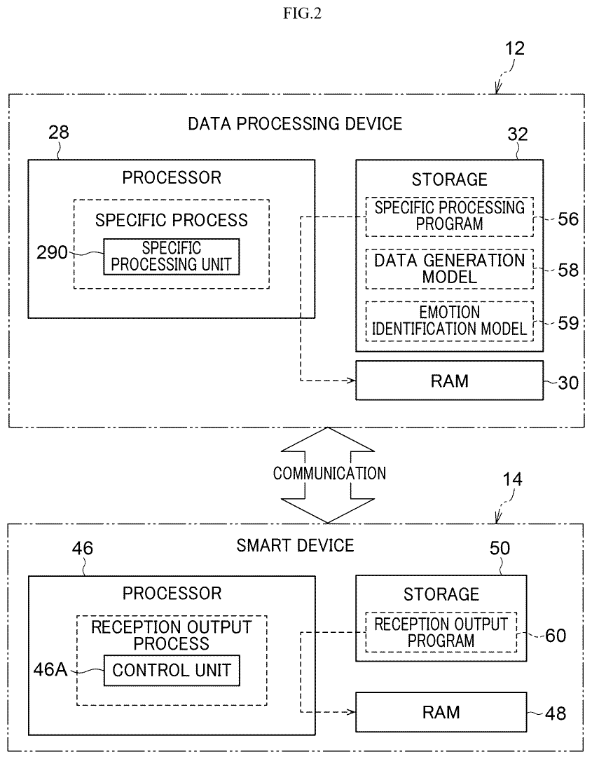

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional internal audit support systems typically rely on static rule sets and manually designed checklists to identify audit check items based on performance information of an organization or an enterprise. In such systems, a processor merely applies pre-defined rules to stored financial or operational records, without effectively exploiting recent advances in generative AI models or leveraging rich contextual information provided in prompt sentences. As a result, the generated audit check items are often generic, insufficiently tailored to the current data set, and unable to adapt to changes in business environments or user preferences.

Further, existing systems generally do not normalize and validate raw performance information in a robust and automated manner. In many deployments, validation and cleansing of input data, such as detection of missing values, inconsistencies, and format anomalies, are performed manually or via ad hoc scripts that are external to the audit support workflow. This fragmentation leads to unstable system behavior, increased processing time, and a higher risk of undetected data quality issues propagating into subsequent audit analyses.

Moreover, although generative AI models can, in principle, produce natural-language audit check items, conventional usage patterns treat these models as isolated text generators. There is no structured mechanism for automatically constructing a consistent context for the generative AI model from validated performance information and user-specified prompt sentences. Without explicit encoding of audit target periods, account categories, or abnormal tendencies into the model input, the generated audit check items can lack specificity, fail to capture critical anomalies in the data, and require extensive manual post-editing.

In addition, known systems rarely incorporate machine-readable audit standard information and regulation information into an automated applicability determination loop. Even if generated audit check items are produced, human experts typically must manually determine applicability with respect to current audit standards, regulations, and internal policies. This manual applicability determination is time-consuming, error-prone, and difficult to scale across multiple entities, audit types, and time periods.

Furthermore, user feedback on generated audit check items is often not captured in a structured form that can be used to improve the underlying generative AI model or the construction of the prompt context. Typical interfaces may allow users to edit or comment on items, but such feedback is treated as one-off corrections rather than as training data to iteratively refine model parameters, prompt templates, and context generation rules.

Consequently, the system is unable to learn from past user interactions, and the quality and relevance of generated audit check items do not systematically improve over time.

Accordingly, there is a need for a computer-implemented system that (i) automatically acquires and normalizes performance information, (ii) constructs rich textual context combining the performance information with a prompt sentence, (iii) uses a generative AI model to generate audit check item candidates in a natural language, (iv) automatically determines applicability of the candidates by referencing stored audit standards and regulation information, and (v) collects and exploits structured user feedback to continuously improve both the generative AI model and the prompt/context construction logic. Such a system should improve the functioning of the computer by orchestrating data validation, text generation, applicability checking, and learning from feedback in an integrated, iterative workflow that reduces manual effort and enhances the precision and adaptability of audit support processing.

The specific processing by the specific processing unit 290 of the data processing device 12 in Example 1 is realized by the following means.

The present invention provides a server comprising a processor and a memory storing instructions that, when executed by the processor, cause the processor to acquire performance information of an organization or an enterprise from a client device, verify a structure and a format of the performance information, detect missing values and inconsistencies, and convert the performance information into an analysis-ready format; generate, based on the analysis-ready performance information and a prompt sentence input by a user, audit check item candidates in a natural language by using a generative AI model, and automatically construct context information for input to the generative AI model, the context information including at least an audit target period, an account category, and an abnormal tendency derived from the performance information; compare the audit check item candidates with audit standard information and regulation information stored in a reference information storage unit, determine applicability and an application degree of the audit check item candidates, and extract applicable audit check items; present the applicable audit check items to the user via a client interface, and acquire, as feedback information, correction content, evaluation information, and comment information provided by the user with respect to the applicable audit check items; generate training data based on a correspondence between the feedback information and the prompt sentence and the context information, update parameters of the generative AI model, and dynamically adjust at least one of a prompt template and a context generation rule so as to continuously improve generation behavior of the generative AI model; and record a generation history of the audit check items, applicability determination results, and the feedback information in the memory as reusable audit knowledge. This enables the computer system to perform an integrated audit support workflow that automatically cleans and normalizes input data, constructs and supplies structured context to a generative AI model, filters generated audit check items based on codified audit standards, and iteratively refines model parameters and prompting logic from user feedback, thereby improving the technical performance, scalability, and adaptability of computer-implemented audit processing.

The term “performance information” refers to electronic data representing operational or financial conditions of an organization or an enterprise, including, but not limited to, transaction records, account balances, revenue figures, expense records, and time-series indicators used for audit analysis.

The term “prompt sentence” refers to a text string input by a user that specifies an audit-related request, constraint, or focus area, and that is used as part of an input to a generative AI model for generating audit check item candidates.

The term “generative AI model” refers to a machine-learned model configured to generate natural-language text, such as audit check item candidates, based on at least a prompt sentence and context information, and including, for example, a neural network implemented using a deep learning framework.

The term “analysis-ready format” refers to a data structure in which performance information has been normalized, validated, and converted into a consistent schema suitable for automated analysis, including standardized data types, resolved missing values where possible, and harmonized codes or categories.

The term “context information” refers to structured or semi-structured data derived from performance information and optionally from other sources, which is combined with a prompt sentence and supplied as input to a generative AI model, and which may include audit target periods, account categories, abnormal tendencies, and summary statistics.

The term “audit check item candidate” refers to a natural-language statement output by a generative AI model that describes a potential audit procedure, verification step, or review action to be considered for use in an audit.

The term “applicable audit check item” refers to an audit check item candidate that has been determined, by automated comparison with audit standard information and regulation information, to satisfy at least one condition for use in a particular audit scenario.

The term “reference information storage unit” refers to a logical or physical storage resource that stores reference data, including audit standard information, regulation information, and internal policy information, which is used to determine applicability of audit check item candidates.

The term “audit standard information” refers to machine-readable data representing requirements, guidelines, or rules established by auditing frameworks or internal policies, which can be programmatically referenced to evaluate audit check item candidates.

The term “regulation information” refers to machine-readable data representing statutory or regulatory requirements issued by a regulatory authority, which are used to determine whether an audit check item candidate complies with applicable legal or regulatory obligations.

The term “applicability” refers to a degree to which an audit check item candidate is relevant to, and compliant with, at least one audit standard or regulation, for a given audit target period, entity, and audit scope.

The term “application degree” refers to an evaluative measure or score indicating a strength or level of applicability of an audit check item candidate to one or more audit standards, regulations, or internal policies.

The term “feedback information” refers to structured data derived from user interactions with applicable audit check items, including corrections, edits, approvals, rejections, ratings, and comments that are used to improve a generative AI model and context generation logic.

The term “training data” refers to a collection of input-output pairs or annotated records constructed from feedback information, prompt sentences, and context information, which is used to train or fine-tune a generative AI model.

The term “prompt template” refers to a predefined pattern or structure for constructing a prompt sentence and associated context information, including placeholders for variable elements such as time periods, account categories, and thresholds.

The term “context generation rule” refers to a rule or algorithm that determines how context information is derived from performance information or other data sources and how such context information is combined with a prompt sentence for input to a generative AI model.

The term “generation history” refers to recorded information describing past executions of a generative AI model, including input prompt sentences, context information, generated audit check item candidates, applicability determination results, and associated timestamps.

The term “reusable audit knowledge” refers to stored data and metadata, including generation history, applicability determination results, and feedback information, which can be referenced in subsequent processing to improve or guide the generation, selection, or refinement of audit check items.

The term “client device” refers to an electronic device operated by a user, such as a workstation, a portable terminal, or a communication terminal, which communicates with the server to transmit performance information, prompt sentences, and feedback information and to receive applicable audit check items.

The term “server” refers to an electronic apparatus comprising at least one processor and at least one memory, configured to execute instructions to perform acquisition and validation of performance information, generation and filtering of audit check item candidates using a generative AI model, and processing of user feedback.

The term “user” refers to a human operator, such as an auditor, an internal control officer, or a system administrator, who interacts with the client device to provide performance information, input prompt sentences, review audit check items, and submit feedback information.

In one embodiment, a server implements a computer-implemented audit support system that cooperates with at least one terminal operated by a user. The server comprises at least one processor, a main memory, a non-volatile storage device, and a network interface.

The server executes an operating system, a database management system, and an application program including a generative AI model module. The terminal comprises a processor, a display, an input interface, a memory, and a communication module, and executes a client application such as a web browser or a native application.

The server uses a database management system such as a relational database server to store performance information, audit standard information, regulation information, generated audit check item candidates, applicability determination results, and feedback information. The server uses an application execution environment such as a Python runtime together with a numerical computation framework such as a tensor-based machine learning library to implement the generative AI model and associated preprocessing and postprocessing functions.

The server receives, from the terminal, performance information files uploaded by the user. The terminal displays a file selection interface on its display and allows the user to select performance information stored in local storage, for example, a financial ledger file, a sales transaction file, or an expense record file. The terminal reads the selected file using an operating system file I/O API and transmits the file data, together with a prompt sentence entered by the user, to the server via a network using a secure protocol.

The server stores the received performance information into a staging area of the database. The server uses a data processing library to load the raw records into an in-memory data structure such as a two-dimensional table object. The server verifies a structure and a format of the performance information by checking a schema, including required columns, data types, and constraints on values. For example, the server checks that a date field is convertible to a standardized datetime representation, that an amount field is a numeric value within a valid range, and that an account code field is present in a master table stored in the database.

The server detects missing values and inconsistencies by scanning the in-memory table and evaluating conditions such as null value presence, duplicated primary keys, or mismatched currency codes. When the server detects an inconsistency, the server logs an error record into an error table and, depending on a rule, either imputes a value (for example, using a median of the corresponding column) or flags the record for exclusion. The server then converts the validated records into an analysis-ready format by applying transformations such as normalization of numerical values, conversion of currencies into a base currency using exchange rate tables, alignment of time zones, and mapping of external account codes to internal standardized codes using reference tables.

The server stores the analysis-ready performance information in a normalized schema in the database. The schema may include a fact table for transactional measures and dimension tables for time, account, organizational unit, and currency. By storing the data in such a schema, the server can execute efficient aggregation and filtering queries that reduce memory usage and processing time when constructing input features for the generative AI model.

The server generates context information for the generative AI model by combining the analysis-ready performance information with the prompt sentence provided by the user. The user enters, through the terminal, a prompt sentence such as “Generate audit check items for the 2023 financial audit” or “Create audit check items focusing on abnormal travel and entertainment expenses in Q2 2023.” The terminal transmits the prompt sentence to the server, and the server stores the prompt sentence in the database linked to the relevant performance information.

The server aggregates the analysis-ready performance information using database queries to compute features such as total revenue per quarter, variance of expenses per department, top-N largest transactions by amount, and occurrence counts of specific account codes. The server uses a data analysis library to convert these query results into compact feature vectors and textual summaries. For example, the server may create a summary text such as “Sales increased by 45% in Q4 compared to Q3. Travel expenses rose by 60% year-on-year. Several large adjustments were recorded in December.”

The server constructs context information by concatenating the prompt sentence and the textual summary into a single input sequence, or by representing the prompt sentence and the summary as separate segments with segment identifiers. The server then tokenizes the context information using a tokenizer associated with the generative AI model, mapping each token to an integer identifier. The server creates an input tensor containing token identifiers, segment identifiers, and positional indices, and stores this tensor in memory as part of the input to the generative AI model.

The server implements the generative AI model as a neural network such as a transformer-based language model comprising an embedding layer, a plurality of self-attention layers, feed-forward layers, and an output layer. The server initializes the model parameters, including weight matrices in the attention and feed-forward layers, and stores the model in a model repository on the storage device. The server loads the model into main memory and, when available, offloads matrix multiplication and other tensor operations to a graphics processing unit through a machine learning framework.

The server feeds the input tensor representing the prompt sentence and the context information into the generative AI model. The server configures generation parameters such as maximum output length, sampling temperature, nucleus sampling threshold, or beam width. The server executes forward passes of the neural network to compute probability distributions over vocabulary tokens at each step of the output sequence. The server selects tokens according to the configured sampling strategy to generate an output text sequence representing one or more audit check item candidates.

The server decodes the generated token sequence into natural-language text and splits the output into individual audit check item candidates, for example, by detecting sentence boundaries or explicit list markers. The server assigns an internal identifier to each audit check item candidate and stores the candidate text, associated prompt sentence, context summary, and generation metadata such as timestamp and model version in the database.

The server determines applicability of each audit check item candidate by referencing audit standard information and regulation information stored in the reference information storage unit. The server tokenizes each candidate text and extracts domain-specific features such as mention of account categories, periods, thresholds, and regulatory terms. The server queries the reference information storage unit to retrieve relevant standards and regulations for the audit scope corresponding to the performance information and the prompt sentence. The server compares the extracted features and keywords with attributes of standards and regulations and assigns an applicability score based on rule-based mappings or a learned classifier.

The server evaluates whether the applicability score exceeds a threshold or whether a candidate matches at least one active standard or regulation for the target period and entity. The server tags each candidate as applicable, partially applicable, or not applicable, and filters out candidates that do not meet minimum applicability criteria. The server stores the applicability status and matched standard identifiers in the database.

The server transmits the applicable audit check items to the terminal via the network. The terminal receives the items in a structured format, parses the items, and displays them on the display as a list or table. The terminal shows, for each item, at least the item text, a category label (for example, “Revenue” or “Expenses”), an applicability status, and references to relevant standards or regulations. The user reviews the items on the terminal, edits the wording where necessary, and adds comments such as “Add threshold of 100,000 per transaction” or “Limit to Q 2 2023 only.” The terminal provides controls for the user to approve, reject, or rate each item.

The terminal collects the user's edits, comments, approvals, rejections, and ratings and sends feedback information to the server. The server receives the feedback information and stores it in a feedback table linked to the corresponding audit check item candidates, prompt sentences, and context information. The server then constructs training data for model improvement by pairing the original input context (prompt sentence and summarized performance information) with the user-approved or user-edited audit check item texts as target outputs.

The server trains or fine-tunes the generative AI model using the constructed training data.

The server defines a loss function such as a cross-entropy loss between predicted token distributions and ground-truth token sequences derived from user-approved text. The server performs backpropagation to compute gradients of the loss with respect to the model parameters and updates the parameters using an optimization algorithm such as stochastic gradient descent or an adaptive optimization method. The server may perform data augmentation by varying the order of items, adding small perturbations to context sentences, or including synonymous phrases, thereby increasing robustness of the model.

The server may also adjust prompt templates and context generation rules based on aggregated feedback statistics. For example, when the server detects that users frequently add explicit monetary thresholds, the server modifies the context generation rule to include numerical thresholds identified from performance information, and modifies the prompt template to instruct the model to include thresholds. The server stores updated prompt templates and generation rules in the database and applies them in subsequent runs.

The server thereby improves internal computer operations in several ways. By normalizing and validating performance information into an analysis-ready format with a defined schema, the server reduces I/O overhead and accelerates query execution in the database. By constructing compact context summaries and feature representations, the server reduces the dimensionality of the data passed into the generative AI model, leading to faster inference and lower memory consumption. By filtering audit check item candidates using codified standards and regulations before presenting them to the user, the server reduces the number of items that must be rendered and transmitted, thereby decreasing network traffic and user interface processing load.

The server also improves computational accuracy by leveraging feedback-driven fine-tuning of the generative AI model. As the server updates model parameters with supervised targets derived from user-approved items, the model generates audit check item candidates that better satisfy audit domain constraints, reducing the frequency of irrelevant or overly generic items. This reduction in error reduces wasted computation spent on generating and evaluating low-quality candidates.

The server employs processing techniques that differ from conventional human workflows.

The server does not merely automate manual checklist generation but instead constructs, for each context, a machine-interpretable representation that encodes multi-dimensional relationships among performance indicators, standards, and user preferences. The neural network architecture processes this representation using attention mechanisms that compute weighted relationships among tokens and features, which has no analog in purely human mental operations. The server uses explicit decision thresholds, loss functions, and gradient-based updates that operate on numerical tensors and internal states that are not present in human-only audit processes.

The server may be implemented in multiple variants. In a first variant, the generative AI model is implemented as a unidirectional transformer language model that generates tokens sequentially. In a second variant, the generative AI model is implemented as an encoder-decoder architecture in which an encoder encodes the prompt sentence and context information into a latent representation and a decoder generates audit check item candidates conditioned on this representation. In a third variant, the server uses an ensemble of models, where a first model generates draft items and a second model re-ranks or edits the drafts, and the server selects final candidates based on combined scores.

The terminal may also be implemented in different forms. In one embodiment, the terminal is a desktop computer running a web browser application that renders a web-based graphical user interface. In another embodiment, the terminal is a mobile computing device running a native application that communicates with the server via a wireless network. In all embodiments, the terminal provides an interface for the user to input a prompt sentence, such as “Generate detailed audit check items for the 2023 quarterly financial audit focusing on revenue and travel expenses,” and for the user to view and modify the generated items.

The user may use the system in various contexts. The user may request items for annual financial audits, quarterly internal control assessments, or specialized reviews focused on specific accounts or risk areas. The server adapts to these contexts by selecting relevant subsets of performance information and reference standards and by constructing context information that reflects specific time periods and account scopes. As a result, the server generates audit check items that are more focused and technically relevant than items produced by generic text generation.

By integrating data normalization, context construction, generative modeling, applicability determination, and feedback-driven learning into a single coordinated system, the server improves the functioning of the computer system as a whole. Processing steps are executed in a specific order and with specific data structures, which reduces redundant computations and intermediate data size. The use of learned models, combined with structured reference information and explicit feedback loops, allows the system to converge toward high-quality output with fewer processing cycles, improving throughput for large-scale audit support scenarios.

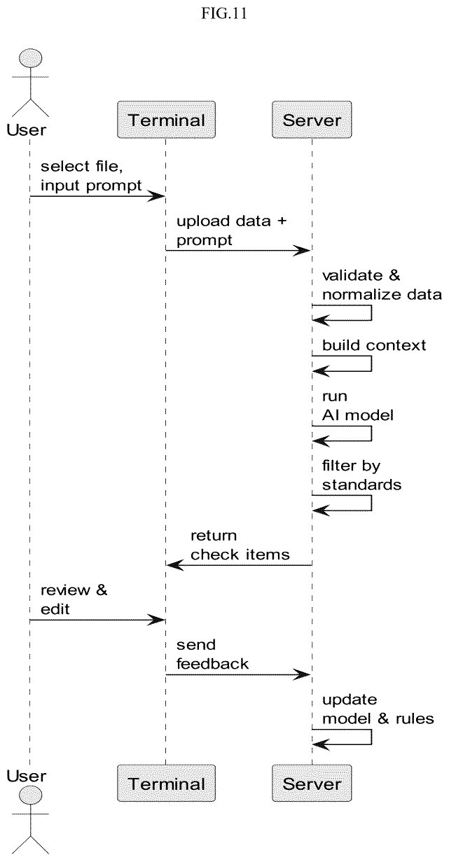

The following describes the processing flow using FIG. 11.

### Step 1

The user selects performance information and inputs a prompt sentence on the terminal. The terminal displays a file selection UI and a text input field. The user chooses at least one performance information file (for example, a financial ledger or an expense record file) and enters a prompt sentence such as “Generate audit check items for the 2023 financial audit” or “Create audit check items focusing on abnormal travel and entertainment expenses in Q2 2023.”

Input: User-selected file(s) stored on the terminal and a prompt sentence typed by the user.

Output: A transmission-ready request object that contains the raw file data and the prompt sentence.

The terminal reads the file content via an operating system file I/O API, encapsulates the binary data and the prompt sentence into a structured request (for example, a multipart HTTP request), and sends the request to the server over a network using a secure protocol.

### Step 2

The server receives and stores the raw performance information and the prompt sentence. The server's network interface accepts the incoming request, and the server parses request headers and body segments.

Input: The request object containing raw file data and the prompt sentence received from the terminal.

Output: Raw performance information records stored in a staging area of a database and the prompt sentence stored in an associated record.

The server writes the uploaded file to a temporary storage location, invokes a data import routine to load file contents into a staging table, and records metadata such as file name, size, upload time, and user identifier. The server stores the prompt sentence in a separate table and links it to the staging data via a dataset identifier.

### Step 3

The server validates and normalizes the performance information into an analysis-ready format. The server loads the staging table into an in-memory tabular structure and checks schema conformity, including required columns, data types, and value ranges.

Input: Raw performance information records from the staging table.

Output: Validated and normalized records stored in a normalized schema (analysis-ready performance information).

The server detects missing values and inconsistencies by scanning each row and column, flags rows with nulls in required fields, and performs data type conversions for fields such as dates and amounts. The server removes or corrects inconsistent records based on predefined rules (for example, dropping records with irreparable errors or imputing missing amounts with median values). The server maps external account codes to standardized codes using a lookup table, converts all amounts to a base currency using stored exchange rates, and writes the cleaned records into fact and dimension tables of a normalized database schema.

### Step 4

The server constructs summary features and textual context from the analysis-ready performance information. The server executes aggregation queries to compute metrics such as total revenue per quarter, department-wise expenses, and variance of key indicators.

Input: Analysis-ready performance information stored in normalized tables.

Output: Numerical feature vectors and textual summary sentences representing key patterns and anomalies.

The server applies grouping and aggregation operations to obtain totals, averages, and standard deviations. The server then analyzes the results to detect abnormal patterns, such as unusually high growth or spikes in specific accounts, and generates textual descriptions like “Sales increased by 45% in Q4 compared to Q3” or “Travel expenses rose by 60% year-on-year.” The server encodes the numerical metrics in feature vectors and concatenates the textual descriptions into a summary string.

### Step 5

The server builds the input sequence for the generative AI model using the prompt sentence and the context. The server retrieves the stored prompt sentence linked to the dataset and combines it with the generated summary.

Input: The prompt sentence from the user and the textual summary plus feature vectors from the analysis-ready data.

Output: A tokenized input tensor comprising token IDs, segment IDs, and positional indices for the generative AI model.

The server constructs a composite text such as “Prompt: [prompt sentence]. Context: [summary].” The server applies a tokenizer to split the composite text into tokens, maps each token to an integer vocabulary index, and generates segment identifiers distinguishing prompt and context parts. The server calculates positional indices for each token and arranges all indices into multi-dimensional arrays that form the input tensor.

### Step 6

The server generates audit check item candidates using the generative AI model. The server loads a transformer-based language model into memory and prepares it for inference.

Input: The input tensor representing the tokenized prompt sentence and context information.

Output: One or more natural-language audit check item candidate texts.

The server feeds the input tensor into the generative AI model, executes forward propagation through multiple attention and feed-forward layers, and obtains probability distributions over vocabulary tokens for each output time step. The server applies a decoding strategy (for example, beam search or nucleus sampling) using parameters such as maximum output length and temperature to select the most likely next token iteratively. The server continues this process until an end-of-sequence condition is met. The server decodes the selected token sequence back into text and splits the text into distinct candidate items, such as “Check for abnormal spikes in Q4 2023 revenue” or “Verify legitimacy of unusually high travel expenses in department A.”

### Step 7

The server evaluates applicability of each audit check item candidate using stored audit standards and regulations. The server accesses reference tables that contain machine-readable audit standard information and regulation information.

Input: Generated audit check item candidate texts and reference information records.

Output: Audit check item records annotated with applicability status and associated standard or regulation identifiers.

The server tokenizes each candidate text, extracts features such as mentioned account categories, time periods, and specific regulatory terms, and matches these features against attributes in the reference information. The server computes an applicability score for each candidate based on rule-based mappings or a trained classifier and compares the score with predefined thresholds. The server labels each candidate as applicable, partially applicable, or not applicable and stores the label along with links to matched standards and regulations.

### Step 8

The server filters applicable audit check items and sends them to the terminal. The server selects only those candidates that satisfy minimum applicability criteria.

Input: Annotated audit check item candidates with applicability labels.

Output: A filtered list of applicable and partially applicable audit check items transmitted to the terminal.

The server constructs a response payload containing item texts, categories, applicability statuses, and associated standard identifiers. The server serializes the payload into a structured format and sends it over the network to the terminal using a response message.

### Step 9

The terminal displays the applicable audit check items and collects user feedback. The terminal receives the response payload, parses its structure, and renders the items on the display as a list or table.

Input: The filtered list of applicable audit check items and associated metadata received from the server.

Output: Structured feedback information containing user edits, ratings, approvals, and comments.

The terminal provides UI controls that allow the user to edit item text, mark items as approved or rejected, assign relevance scores, and enter comments. The user interacts with these controls to refine the items, for example, by changing “policy thresholds” to “policy threshold of 100,000 per transaction” or by limiting an item to a specific quarter. The terminal aggregates the edits, decisions, and comments into a feedback object and sends the feedback object back to the server via a network request.

### Step 10

The server stores and analyzes feedback information. The server receives the feedback object and validates that referenced item IDs and dataset IDs exist in the database.

Input: Feedback information from the terminal linked to specific audit check item candidates and prompt sentences.

Output: Persisted feedback records and derived statistics about model performance and user preferences.

The server writes each feedback entry to a feedback table containing fields such as original text, edited text, approval status, rating, and user identifier. The server executes analytical queries to compute metrics such as approval rates by category, common patterns in user edits, and frequent rejection reasons. The server aggregates these metrics to identify systematic weaknesses in the generated items, for example, frequent lack of explicit thresholds or insufficient temporal specification.

### Step 11

The server constructs training data from feedback and updates the generative AI model and context generation rules. The server selects feedback entries that meet criteria for training, such as items with approved or edited final text.

Input: Feedback records, original prompt sentences, and associated context information.

Output: Updated generative AI model parameters and adjusted prompt templates and context generation rules.

The server forms input-output pairs where the input includes the tokenized prompt sentence and context, and the output is the tokenized approved item text. The server computes a loss value based on divergence between model-predicted token distributions and ground-truth tokens, backpropagates gradients through the model, and updates model weights using an optimization algorithm. In parallel, the server modifies prompt templates and context generation rules when patterns in feedback indicate systematic preferences, such as always including monetary limits or specifying audit periods explicitly. The server stores the updated model and rules, which will be used in subsequent executions to generate more accurate and user-aligned audit check items.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional internal audit support systems mainly provide static checklists and fixed rule sets that are manually defined and periodically updated. Such systems require extensive human effort to interpret large volumes of performance information of organizations or enterprises, to design and maintain audit items, and to determine applicability of respective audit items in view of dynamically changing financial conditions. As a result, the systems are often unable to react in real time to changes in financial indicators, and cannot flexibly adapt audit content to different organizations, business models, or risk profiles. In addition, in many conventional architectures, performance information is merely stored and displayed, and audit personnel must manually map that information to relevant audit procedures. The processing of performance information, the generation of audit check items, and the determination of applicability are not integrated in a single computational flow. This leads to duplicated data operations, inefficient use of computing resources, and increased latency in preparing and updating audit plans. The lack of a structured transformation from raw performance information into machine-evaluable applicability conditions also prevents automation and makes it difficult to maintain consistency and traceability in audit decisions.

Further, even when generative information processing models are used, they are often invoked ad hoc, with prompt sentences crafted manually and without systematic use of stored evaluation results or prompt histories. Such use does not fully leverage the computing device's capability to refine prompt sentences based on prior interactions, nor to iteratively optimize audit content. The absence of feedback-driven prompt management means that the quality and relevance of generated audit items depend heavily on individual user skill, and cannot be reliably reproduced or scaled across different systems.

Moreover, existing systems generally treat terminals as passive display devices and do not utilize terminal-side interaction data as structured feedback to improve server-side models and logic. Evaluation results and user comments are frequently stored in unstructured formats, or not linked to the generation conditions, such as specific prompt sentences or performance indicators. This makes it difficult for the computing infrastructure to correlate evaluation outcomes with the underlying generation context, hindering any systematic improvement of audit content or applicability rules.

In addition, the psychological burden on users conducting internal audits is not sufficiently addressed. Conventional systems do not incorporate an emotion processing function that recognizes user emotional states and adjusts advisory information accordingly. As a result, user interfaces and system responses can be cognitively overwhelming or poorly timed, reducing the effectiveness and usability of the audit support system, and ultimately impairing the overall performance of the computing environment.

Accordingly, there is a need for an improved computer-implemented system that automatically preprocesses performance information, generates and structures audit check items and applicability conditions using a generative information processing model, evaluates applicability by comparison with computed audit evaluation indicators, and logs all such processing in a persistent, queryable form. There is also a need for a system that closes the loop by using terminal-originated evaluation information and histories of prompt sentences to dynamically update prompt content and audit item definitions. Furthermore, there is a need to integrate an emotion processing function that adapts server outputs to user emotional states, thereby improving the efficiency, reliability, and user experience of the overall computing system.

The specific processing by the specific processing unit 290 of the data processing device 12 in Application Example 1 is realized by the following means.

The present invention provides a server comprising a processor, a storage device, and a communication interface, the processor being configured to execute instructions to acquire performance information related to an organization or an enterprise via the communication interface, to perform preprocessing on the performance information including at least correction of missing values, unification of formats, and normalization of numerical indicators, and to store preprocessed information in the storage device, to confirm requirements in an audit process based on the preprocessed information and to calculate audit evaluation indicators used for verification of a financial situation, to generate or obtain a prompt sentence including an instruction relating to the requirements and the audit evaluation indicators, to input the prompt sentence and the audit evaluation indicators to a generative information processing model and to cause the generative information processing model to generate response information including audit check items and applicability conditions corresponding to the audit check items, to analyze the response information and to extract the audit check items and the applicability conditions as structured data, to compare the applicability conditions with the audit evaluation indicators and to determine applicability and priority for each of the audit check items and to add determination results to the structured data, to record the structured data and the determination results in the storage device as record information together with identification information and time information, to generate delivery information including the audit check items and the determination results in a form suitable for display or presentation by a terminal and to transmit the delivery information to the terminal via the communication interface, to acquire, from the terminal, evaluation information including applicability, implementation status, or comments by a user regarding the audit check items and to additionally store the evaluation information in the storage device as part of the record information, to generate a new prompt sentence based on the evaluation information and a history of the prompt sentences and to update contents of subsequent inquiries to the generative information processing model, and to recognize an emotional state of the user and generate advisory information according to the emotional state and the determination results of the audit check items and provide the advisory information to the terminal using an emotion processing function. This enables improvement of computer functionality by transforming raw performance information into structured, model-driven audit artifacts through a unified processing pipeline, by automatically adapting generative model prompts and audit content based on logged evaluation feedback and prompt histories, and by dynamically adjusting server responses to user emotional states, thereby enhancing processing efficiency, responsiveness, and usability of the audit support system implemented on the computing infrastructure.

The term “performance information” refers to numerical or textual information indicating operational or financial conditions of an organization or an enterprise, including but not limited to revenues, expenses, assets, liabilities, and derived management indicators.

The term “preprocessing” refers to a series of data processing operations applied to raw performance information, including at least correction of missing values or errors, unification of data formats and types, and normalization or scaling of numerical indicators into a form suitable for subsequent computational analysis.

The term “requirements in an audit process” refers to conditions, criteria, or procedures that are to be satisfied or followed when verifying a financial situation or compliance status of an organization or an enterprise.

The term “audit evaluation indicators” refers to quantitative or qualitative indicators computed from preprocessed performance information and used to evaluate, verify, or monitor financial conditions or risks in an audit process.

The term “prompt sentence” refers to a text string including at least one instruction or request provided to a generative information processing model to cause the model to generate output content related to audit check items or other audit-relevant information.

The term “generative information processing model” refers to a computational model, such as a generative artificial intelligence model, configured to generate text or structured output in response to an input including a prompt sentence and optionally additional context.

The term “response information” refers to data output from the generative information processing model in response to an input including a prompt sentence and audit evaluation indicators, the data including at least audit check items and applicability conditions corresponding to the audit check items.

The term “audit check item” refers to an itemized condition, question, or procedure to be reviewed, tested, or confirmed during an audit process.

The term “applicability condition” refers to a condition, rule, or criterion indicating when or under what circumstances a particular audit check item should be applied or executed.

The term “structured data” refers to data organized in a predefined schema or format, such as records, fields, or key-value pairs, enabling programmatic retrieval, analysis, and storage of audit check items and applicability conditions.

The term “applicability” refers to a determination result indicating whether a particular audit check item is relevant or should be executed under a given set of audit evaluation indicators or conditions.

The term “priority” refers to a classification or ranking associated with an audit check item that represents relative importance, urgency, or recommended execution order of the audit check item.

The term “determination results” refers to information indicating at least applicability and priority of each audit check item, derived from comparison between applicability conditions and audit evaluation indicators.

The term “record information” refers to data stored in a storage device including at least structured data for audit check items, determination results, associated identification information, and time information, maintained as an audit-related history.

The term “delivery information” refers to information generated for transmission to a terminal, the information including at least audit check items and determination results in a form suitable for display or presentation by the terminal.

The term “terminal” refers to an information processing apparatus, such as a portable communication device, wearable device, or other user interface device, configured to communicate with the server, display or present delivery information, and transmit user input as evaluation information.

The term “evaluation information” refers to information provided from the terminal to the server, including at least user-specified applicability, implementation status, or comments regarding one or more audit check items.

The term “prompt sentence history” refers to a collection of previously used prompt sentences and metadata associated with those prompt sentences, such as timestamps or related audit sessions, stored for later reference or reuse.

The term “communication interface” refers to hardware and software components configured to transmit and receive data between the server and one or more terminals or external systems via a communication network.

The term “emotion processing function” refers to a set of operations or modules configured to recognize an emotional state of a user based on input information and to generate advisory information adjusted according to the recognized emotional state.

The term “emotional state” refers to a status or condition of a user's feelings or psychological disposition, such as stress level, frustration, confidence, or satisfaction, inferable from user interactions, biometric signals, or other indicators.

The term “advisory information” refers to information generated by the server for presentation to the user, the information including at least guidance, recommendations, or explanations related to audit check items or audit processing, and being adapted according to an emotional state and determination results.

In one embodiment, a server executes a computer program on a hardware platform including at least one processor, a main memory, a non-transitory storage device, and a communication interface connected to a communication network. The server uses a software stack that may include an operating system, a database management system, a web application framework, and numerical computation libraries. For example, the server may employ a UNIX-compatible operating system, a relational database management system, a web application framework implementing HTTP endpoints, and numerical libraries supporting matrix operations and statistical computations. The server further communicates with one or more terminals, such as portable communication devices or wearable devices, which provide user interfaces for displaying audit check items and acquiring user input.

The server stores performance information related to organizations or enterprises in a structured data format. The server represents performance information as records in database tables, each record including fields such as reporting period, revenue, expense categories, asset values, liability values, and identifiers for the organization. The server additionally stores derived audit evaluation indicators, prompt sentences, audit check items, applicability conditions, and evaluation information in separate but relationally linked tables. By using normalized relational schemas, the server reduces redundancy and improves query performance when retrieving or aggregating audit-related data.

The server performs preprocessing on raw performance information using a numerical computation environment and data processing libraries. The server, for example, employs a data frame abstraction to load raw records from the storage device, detect missing values, and perform imputation based on statistical properties such as mean, median, or regression estimates within each financial category. The server unifies data formats by converting date strings to a canonical timestamp representation, normalizing currency units, and enforcing consistent data types for numerical fields. The server normalizes numerical indicators by applying z-score normalization or min-max scaling, using functions implemented in a machine learning utility library. The server writes the preprocessed performance information back to the storage device, so that subsequent components can access homogeneous and normalized data.

The server calculates audit evaluation indicators by executing deterministic algorithms over the preprocessed performance information. The server, for instance, computes current ratio, quick ratio, debt-to-equity ratio, operating margin, and revenue growth rate by combining normalized numerical fields according to predefined formulas. The server stores both the computed values and their computation parameters (such as time windows, thresholds, and aggregation functions) in an analysis table. The server may implement these calculations using vectorized operations in a numerical library, which improves computational efficiency compared to record-by-record processing and reduces latency when processing large volumes of performance records.

The server generates or acquires prompt sentences that are used as inputs to a generative AI model. The server may construct a prompt sentence automatically by concatenating template text with current audit evaluation indicators. For example, the server may generate a prompt sentence such as “Based on the organization's latest performance data, generate internal audit check items for security and access control, and indicate applicability for each item.”

Alternatively, the server may acquire a prompt sentence that a user enters at a terminal, such as “Using the most recent quarterly financial data, generate audit check items focused on data protection compliance and classify each item as required or optional.” The server stores each prompt sentence, together with metadata such as organization identifier, timestamp, and associated evaluation indicators, to form a prompt sentence history.

The server interfaces with a generative AI model that is implemented, for example, as a neural network-based language model. In one embodiment, the generative AI model is a transformer-based neural network, including an embedding layer, multiple self-attention layers, feedforward layers, and a final decoding layer that outputs a probability distribution over token sequences. The server provides the prompt sentence and a compact textual representation of audit evaluation indicators as input tokens to the generative AI model. The server may, for instance, construct a context string such as “Current ratio: 1.2; Debt-to-equity ratio: 2.5; Revenue growth: −5%,” append this string to the prompt sentence, and then tokenize the combined text using a subword tokenization algorithm.

The server configures the generative AI model with hyperparameters such as number of attention heads, number of layers, hidden dimension size, and vocabulary size. The server may execute the generative AI model using a numerical computation framework that supports GPU acceleration, enabling efficient parallel computation of attention scores and matrix multiplications. During training of the generative AI model, which may be performed offline, the server supplies training examples consisting of input prompt sentences and target text describing suitable audit check items and applicability conditions. The server uses a loss function such as cross-entropy loss between predicted token distributions and ground truth tokens, and updates model weights using a gradient-based optimization algorithm such as stochastic gradient descent or Adam. The server may also employ data augmentation methods, such as paraphrasing of prompt sentences or synthetic variation of financial indicator contexts, to improve robustness of the generative AI model.

The server, during inference, invokes the trained generative AI model and obtains response information in the form of generated tokens that are decoded into audit check items and applicability conditions. The server controls generation parameters such as temperature, top-k or top-p sampling thresholds, and maximum sequence length to balance diversity and determinism of the generated output. The server then analyzes the response information using parsing algorithms. The server may, for example, apply pattern matching to identify list structures, headings, and key phrases such as “if,” “when,” or “in case,” to segment the generated text into individual audit check items and corresponding applicability conditions.

The server transforms the parsed result into structured data. The server assigns each audit check item a unique identifier, a textual title, a detailed description, and an applicability condition field. The server may represent the structured data in a key-value format or as rows in a database table. For applicability conditions, the server may convert natural language phrases into a rule representation, for example by mapping comparative expressions to threshold tests over audit evaluation indicators. The server may use a rule engine or rule interpretation module to represent each applicability condition as a set of predicates over indicator values, such as “revenue_growth<−0.03” or “debt_to_equity_ratio>2.0.”

The server determines applicability and priority of each audit check item by executing rule evaluation algorithms over the audit evaluation indicators. The server loads the indicators from the analysis table and applies each predicate set defined in the applicability condition.

When an applicability condition is satisfied, the server marks the corresponding audit check item as applicable and assigns a priority level based on rule configuration, such as high priority for conditions indicating high risk or negative trends. The server stores determination results as fields associated with each audit check item, including a binary or multi-level applicability flag and a priority score. By using rule-based evaluation implemented in software, the server can systematically and reproducibly apply complex combinations of indicator thresholds and logical operators, reducing the risk of inconsistent manual interpretations.

The server writes the structured data, including audit check items, applicability conditions, and determination results, to the storage device as record information. The server appends identification information such as organization identifier, audit session identifier, and user identifier, as well as time information representing generation time and evaluation time. The server indexes the record information using database indices on identifiers and time fields, enabling efficient retrieval by organization and period. This structured and indexed storage improves data management by supporting fast queries across large historical datasets and by providing a clear linkage between generated content, source performance information, and subsequent user evaluations.

The server generates delivery information for terminals. The server converts the structured data into a format suitable for display, for example a hierarchical JSON-like structure or a list of items with attributes that the terminal can render as a user interface. The server may filter the audit check items based on applicability or priority, so that terminals do not need to process unnecessary items. The server then transmits the delivery information via the communication interface using a network protocol such as HTTPS. By performing filtering and aggregation at the server, the system reduces communication load and terminal-side processing, which is particularly beneficial when terminals are constrained devices or operate over limited bandwidth.

The terminal receives the delivery information and renders a user interface that lists audit check items, descriptions, applicability indications, and priority levels. The terminal may be implemented using a mobile operating system with native UI components, or a wearable device platform with a heads-up display. The terminal parses the delivery information using its own JSON or structured data parser and maps fields to UI elements. For applicable and high-priority items, the terminal can use visual cues such as color or icons. By offloading most computational processing to the server and limiting the terminal to parsing and rendering, the system improves energy efficiency at the terminal and maintains consistent presentation across different terminal types.

The user reviews the displayed audit check items on the terminal and provides evaluation information, such as whether a particular item is actually applicable, whether it has been completed, and any comments or observations. The terminal captures user input via touch, keyboard, or voice interfaces and encodes this input as structured evaluation information linked to audit check item identifiers. The terminal then transmits the evaluation information back to the server using the communication interface.

The server receives the evaluation information and stores it as part of the record information.

The server links each evaluation record to the corresponding audit check item, prompt sentence, and performance information context. The server may compute aggregated statistics, such as counts of items frequently marked as not applicable, and use these to refine future generation behavior. By maintaining this bidirectional linkage and storing evaluation information in structured form, the server improves traceability of audit decisions and supports later analysis or recomputation.

The server generates new prompt sentences using the prompt sentence history and evaluation information. The server may implement an algorithm that analyzes patterns in user evaluations, such as consistent marking of certain types of items as not applicable, and adjusts subsequent prompt sentences to refine the focus or constraints given to the generative AI model. For example, when evaluation information indicates that many revenue-related items are completed but access control-related items remain problematic, the server may generate a new prompt sentence such as “Generate additional detailed audit check items specifically for access control, prioritizing high-risk areas based on current performance indicators.” The server can construct such prompt sentences by using templates and variable substitution, or by using a secondary model trained to propose improved prompts. This feedback-based adaptation is not a mere automation of manual prompt writing; it formulates prompt generation as a reproducible and data-driven process that is executed by the server according to defined algorithms, which enhances the consistency and effectiveness of generative outputs.

The server includes an emotion processing function that recognizes a user's emotional state and adjusts advisory information accordingly. The server may receive from the terminal biometric indicators, interaction metrics (such as rapid repeated taps or long pauses), or explicit user feedback, and then extract features such as input speed, error frequency, or voice tone descriptors. The server may apply a classifier, for example a neural network or a support vector machine, trained to map these features to emotional state categories like “stressed,” “fatigued,” or “confident.” Based on the recognized emotional state and the determination results for audit check items, the server generates advisory information that might, for example, simplify explanations, propose step-by-step guidance, or prioritize more critical items first when the user is under stress. This emotion-responsive adaptation reduces cognitive load on the user and can improve accuracy and speed in processing audit items, thereby improving overall system performance as a human-computer system.

The server improves computer technology by integrating the generative AI model, rule-based applicability evaluation, structured storage, and feedback-driven prompt adaptation into a unified processing pipeline. The server reduces redundant processing by performing normalization and indicator computation once at the server side and reusing these values both for model input and for rule evaluation. The server reduces communication overhead by filtering and encoding delivery information based on applicability and priority before transmission to terminals. The server improves computational efficiency by using vectorized operations and parallelizable neural network computations for generation, instead of per-item manual assembly or ad hoc scripts. The server improves accuracy and consistency by systematically converting natural language output from the generative AI model into structured rules that are applied deterministically across all items and organizations.

In another embodiment, the server may deploy the generative AI model locally rather than through an external service. In this case, the server loads model parameters from the storage device to main memory, executes forward passes through the transformer layers using a numerical library capable of leveraging specialized hardware such as graphics processing units, and manages batching of multiple prompt sentences to increase throughput. In yet another embodiment, the server may employ a hybrid pipeline where a generative AI model proposes candidate audit check items and a separate, smaller discriminative model evaluates and ranks these candidates against historical acceptance patterns and evaluation data, thus further enhancing relevance and reducing noise in the final audit checklist.

The server may additionally implement alternative rule engines or logic representations for applicability conditions. For example, the server may represent applicability conditions as decision trees, Boolean expressions, or constraint satisfaction problems, and execute corresponding evaluation algorithms over the audit evaluation indicators. Different representations can be selected depending on the desired trade-off between expressiveness and computational cost. The server may also cache intermediate evaluation results to avoid recomputation when the same indicators are reused across multiple audit sessions or organizations.

The terminal may vary in form. In one implementation, the terminal is a smartphone that uses a graphical list-based interface to show audit check items. In another implementation, the terminal is a wearable device such as smart glasses that overlays key audit items within a user's field of view while inspecting physical locations. In yet another implementation, the terminal is a desktop workstation that offers a more complex interface, including charts and drill-down views. In all these variants, the server delivers data in a structured format and the terminal remains responsible primarily for rendering and capturing user input, which isolates heavy computational processing to the server and fosters scalability.

By structuring performance information, audit evaluation indicators, generative AI model outputs, applicability rules, user evaluations, and emotional state assessments into a single, technically integrated framework, the server does more than automate existing human actions. The server implements specific data structures, neural network configurations, rule engines, and feedback algorithms that collectively transform how audit information is computed, transmitted, and adapted. This leads to measurable technical effects including reduced processing time for generating tailored audit checklists, reduced error rates in applicability assessment, improved utilization of network and storage resources, and enhanced stability and reproducibility of audit decision logs, all of which represent concrete improvements in the functioning of the computer system itself.

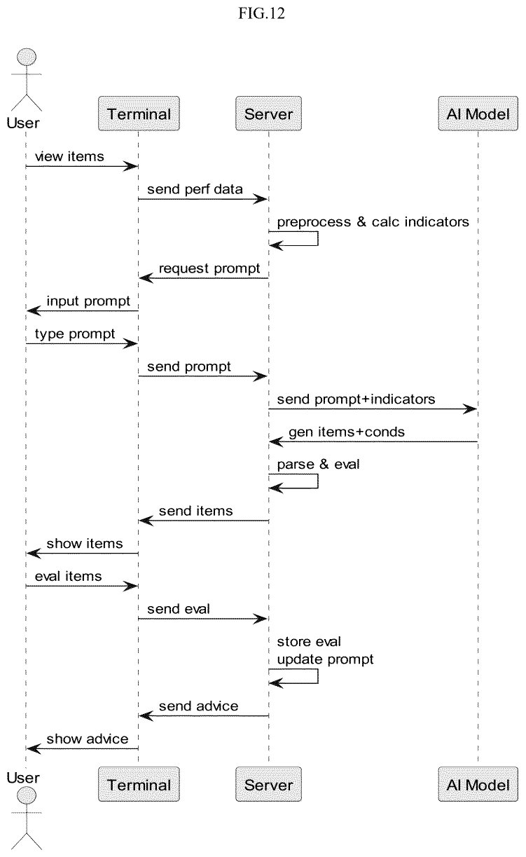

The following describes the processing flow using FIG. 12.

### Step 1

Server receives raw performance information related to an organization or an enterprise via the communication interface. The input is raw performance data records including fields such as date, revenue, expenses, assets, and liabilities in CSV, JSON, or database form. Server validates the input by checking required fields, data types, and value ranges, and rejects or flags inconsistent records. Server then stores the validated raw records in a relational table in the storage device, using an insert operation that assigns organization identifiers and timestamps as primary keys. The output of this step is a set of stored raw performance records ready for preprocessing.

### Step 2

Server loads the raw performance records from the storage device and performs preprocessing. The input is the stored raw performance records. Server uses data-processing routines to detect missing values, out-of-range values, and inconsistent formats (for example, different date formats or currency units). Server imputes missing numerical values using statistical methods such as mean, median, or regression within each category, converts all dates to a unified timestamp format, and converts monetary fields to a common currency.

Server normalizes numerical indicators using z-score normalization or min-max scaling across a selected time window. Server writes the preprocessed records into a separate normalized table. The output of this step is a set of preprocessed and normalized performance records with consistent schema and value ranges.

### Step 3

Server calculates audit evaluation indicators based on the preprocessed performance records. The input is the normalized performance data for one or more reporting periods. Server executes arithmetic and aggregation operations to compute indicators such as current ratio, quick ratio, debt-to-equity ratio, operating margin, and revenue growth rate. Server applies formulas over vectors or matrices of normalized values to avoid row-by-row calculation, thereby reducing computation time. Server stores the computed indicators and the parameters used (such as period length and thresholds) in an analysis table linked to the corresponding organization and period. The output of this step is a set of audit evaluation indicators associated with each organization and reporting period.

### Step 4

Server generates or acquires a prompt sentence to be used for the generative AI model. The input is the set of audit evaluation indicators and optionally user configuration information.

Server constructs a prompt sentence automatically by filling a template with references to the indicators, or receives a prompt sentence sent from the terminal. For example, user may provide a prompt sentence such as “Based on the organization's latest performance data, generate internal audit check items for security and access control, and indicate applicability for each item.” Server stores the prompt sentence in a prompt history table with a timestamp and a link to the relevant performance data. The output of this step is a selected prompt sentence associated with a specific data context.

### Step 5

Server composes a model input context that combines the prompt sentence and a compact representation of the audit evaluation indicators. The input is the prompt sentence and the numerical indicator values. Server formats the indicators into a human-readable context string, for example “Current ratio: 1.2; Debt-to-equity ratio: 2.5; Revenue growth: −5%,” and concatenates this string with the prompt sentence. Server tokenizes the combined text into subword tokens according to the vocabulary of the generative AI model. Server creates an input tensor that encodes token identifiers and positional indices. The output of this step is a model input tensor ready to be processed by the generative AI model.

### Step 6

Server executes the generative AI model to obtain response information including audit check items and applicability conditions. The input is the model input tensor and the trained model parameters. Server performs a forward pass through the neural network architecture, including embedding lookup, self-attention computations, feedforward transformations, and decoding operations. Server computes attention weights and intermediate hidden states across multiple layers to predict probability distributions over the next token at each position. Server uses a decoding strategy, such as greedy decoding or top-k sampling with a specified temperature, to generate a sequence of output tokens that form textual response information.

The output of this step is generated text that describes multiple audit check items and their applicability conditions in natural language.

### Step 7

Server parses the generated response information and converts it into structured data. The input is the generated text containing list-like descriptions of audit check items and associated conditions. Server uses pattern recognition and parsing rules to detect item delimiters (such as numbered lists or bullet markers) and splits the text into individual audit check item segments. For each segment, server identifies a title, a descriptive body, and any phrases indicating conditions (for example, expressions beginning with “if,” “when,” or “in case”).

Server maps these parts into a structured representation, such as records with fields for item identifier, title, description, and raw applicability condition text. The output of this step is a structured list of audit check items and textual applicability conditions.

### Step 8

Server converts textual applicability conditions into machine-evaluable rules and evaluates applicability and priority. The input is the structured list of audit check items and the audit evaluation indicators. Server applies rule-extraction logic that maps common comparative phrases and numeric thresholds in the textual conditions to predicate expressions referencing the indicator fields, such as “revenue_growth<−0.03” or “debt_to_equity_ratio>2.0.”

Server stores these predicate expressions in a rule format used by a rule engine. Server then executes the rule engine, which evaluates each predicate set against the current indicator values. For each audit check item, server determines whether the rule evaluates to true or false, sets an applicability flag, and assigns a priority score based on predefined mappings between indicator ranges and risk levels. The output of this step is a set of audit check items augmented with applicability flags, priority levels, and associated evaluation details.

### Step 9

Server records audit check items, applicability, and priority in the storage device as record information. The input is the augmented structured list from Step 8. Server creates or updates database records for each audit check item, storing item identifiers, titles, descriptions, predicate rules, applicability flags, priority scores, organization identifiers, and timestamps. Server also stores links to the originating prompt sentence and performance data context, enabling traceability. Server creates indices on key columns such as organization identifier, period, and applicability flag to speed up future queries. The output of this step is a persistent, queryable record of generated and evaluated audit check items.

### Step 10

Server generates delivery information for transmission to terminals. The input is the stored record information for a selected organization and period. Server retrieves the relevant audit check items using database queries, optionally filtering items by applicability or priority (for example, only high-priority applicable items). Server packages the retrieved items into a compact response structure, including only fields needed by terminals, such as item identifier, title, short description, applicability flag, and priority level. Server serializes this structure into a format suitable for network communication. The output of this step is delivery information ready to be transmitted to one or more terminals.

### Step 11

Terminal receives the delivery information from the server and prepares a user interface. The input is the delivery information including the list of audit check items and their attributes. Terminal parses the received data structure into in-memory objects and maps each field to user-interface elements. Terminal orders the audit check items, for example by priority, and prepares visual representations such as list entries with labels and status indicators. Terminal may cache the data locally to enable offline viewing or to reduce repeated requests. The output of this step is an internal representation of the audit check items ready to be displayed to the user.

### Step 12

Terminal displays the audit check items and determination results to the user. The input is the internal representation of audit items created in Step 11. Terminal renders the items on a display, showing for each item the title, summary description, applicability flag, and priority. Terminal may use layout rules to group items by category or to highlight high-priority applicable items with special colors or icons. Terminal also presents interactive controls, such as checkboxes, dropdowns, or buttons, to allow the user to indicate applicability, completion status, or comments. The output of this step is a graphical or visual interface presented on the terminal's display.

### Step 13

User reviews the displayed audit check items and provides evaluation information. The input is the displayed audit checklist interface. User reads each item, considers the given applicability indication and priority, and determines whether the item is actually applicable in practice, whether it has been completed, and whether any notes should be added. User performs input operations on the terminal, such as tapping controls to mark applicability, selecting completion status, and typing or dictating textual comments. The output of this step is user-generated evaluation content captured by the terminal's input mechanisms.

### Step 14

Terminal converts the user's interactions into structured evaluation information. The input is the raw input events and selections provided by the user in Step 13. Terminal associates each input with the corresponding audit check item identifier, encodes applicability decisions, completion status, and comment text into a structured record format, and attaches timestamps and user identifiers if available. Terminal stores these records temporarily in local memory or local storage to ensure they are not lost if communication is interrupted. The output of this step is a set of structured evaluation records ready to be sent to the server.

### Step 15

Terminal transmits the evaluation information to the server. The input is the structured evaluation records created in Step 14. Terminal establishes or reuses a network connection to the server and sends the evaluation information via the communication interface using an appropriate protocol. Terminal may batch multiple evaluation records into a single request to reduce overhead and retry the transmission in case of temporary failures. The output of this step is the delivery of evaluation information from the terminal to the server.

### Step 16

Server receives the evaluation information and updates record information. The input is the evaluation information transmitted from one or more terminals. Server validates each evaluation record by checking that the referenced audit check item exists and belongs to the correct organization, and that status values are within allowed sets. Server writes each valid evaluation record into an audit log table and updates summary fields associated with each audit check item, such as the latest applicability decision and completion status. Server also links the evaluation records to the originating prompt sentence and performance data context. The output of this step is an updated set of record information including both generative outputs and user evaluations.

### Step 17

Server analyzes the accumulated evaluation information and prompt sentence history to generate refined prompt sentences. The input is the stored evaluation records and the stored prompt sentences. Server executes algorithms that detect patterns, such as frequent marking of certain types of items as not applicable or frequent user comments indicating missing coverage in certain areas. Server uses these patterns to adjust constraint clauses or focus areas in new prompt sentences. For example, server may generate a refined prompt sentence such as “Using the most recent quarterly financial data, generate audit check items focused on data protection compliance and exclude items already consistently marked as not applicable in prior sessions.” Server stores the newly generated prompt sentences and associates them with updated generation parameters. The output of this step is a set of refined prompt sentences designed to produce more relevant audit check items in subsequent generations.

### Step 18

Server recognizes a user's emotional state and generates advisory information tailored to that state. The input is user interaction data and, where available, biometric or behavioral indicators provided by the terminal, such as interaction speed, error frequency, or voice characteristics. Server extracts numerical and categorical features from this input, such as average response time per item or variability in interaction pace. Server applies an emotion classification model or rule set that maps these features to emotional states such as “stressed” or “confident.” Based on the recognized emotional state and the current determination results for audit check items, server generates advisory information, for example by choosing between more detailed explanations or concise summaries, and by recommending a processing order that reduces user stress. The output of this step is advisory information that is linked to the user's emotional state.

### Step 19

Server transmits the advisory information and any refinements in audit content to the terminal. The input is the advisory information and, if applicable, updated audit check item data resulting from refined prompt sentences or adjusted rules. Server packages this information into a suitable format and sends it to the terminal via the communication interface. Terminal receives this information and updates the displayed interface, for example by showing guidance messages or rearranging item ordering. The output of this step is an updated display context on the terminal that reflects both system-determined applicability and user-adaptive advice.

### Step 20

Server iteratively repeats the generation, evaluation, and adaptation cycle to continuously improve the quality and efficiency of audit support. The input is the entire accumulated history of performance data, generated audit check items, applicability determinations, evaluation information, refined prompt sentences, and emotional state assessments. Server periodically or on demand re-runs the generative AI model with updated prompt sentences, re-evaluates applicability under new performance conditions, and updates storage and delivery information. Server thus refines its internal models, rules, and data structures over time. The output of this step is a continuously optimized set of audit check items, applicability decisions, and advisory content that improves processing speed, relevance, and reliability for subsequent audit sessions.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional audit-support systems primarily rely on static checklists and manually configured rules to determine documents and procedures required for audit handling. In such systems, a processor typically retrieves predefined audit items from a data store and presents them to a user without dynamically adapting to the specific attributes, performance data, or historical audit behavior of a particular organization. As a result, the system frequently presents audit items that are unnecessary or inapplicable for the specific organization, and omits items that become relevant as the audit preparation progresses. This leads to redundant user operations, repeated manual adjustments, and inconsistent audit preparation quality. Furthermore, in conventional architectures, any update of audit check items in response to new regulations, new organizational conditions, or changes in preparation progress is often performed manually by an operator or auditor. The processor does not automatically learn from interaction histories or progress information accumulated during past and ongoing audits. Consequently, the system fails to improve the relevance and completeness of audit check items over time, and cannot efficiently reuse knowledge gained from prior audit sessions. This limits scalability and increases operational cost.

Additionally, traditional systems treat user interaction as a simple exchange of static instructions and user responses, without considering the user's emotional state. When audit preparation is complex and time-consuming, users may become anxious, confused, or overloaded. Existing systems do not recognize these emotional conditions or adapt the guidance accordingly. This can further degrade the effectiveness of the user interface, reduce user adherence to recommended procedures, and ultimately undermine the reliability of audit preparation supported by the system.

From a computer-technology standpoint, these limitations manifest as inefficient use of processing resources and data: (i) the processor does not leverage organization data, audit history, or real-time progress information to generate optimized, context-sensitive instructions; (ii) the processor does not systematically use generative models to synthesize audit check items and associated materials and procedures tailored to a particular audit context; and (iii) the processor does not integrate emotion recognition with automated audit guidance in a closed feedback loop. Therefore, there is a need for a system and a processor configuration that improve computer functionality by dynamically generating and updating audit check items, associated materials and procedures, and user-specific guidance, using generative AI models, structured prompt sentences, historical interaction data, and user emotional state information.

The specific processing by the specific processing unit 290 of the data processing device 12 in Example 2 is realized by the following means.

The present invention provides a server comprising a processor configured to confirm, based on organization data including attribute information and performance information of an organization, requirements to satisfy an audit process; to generate a prompt sentence to be input to a generative AI model based on the organization data and audit check items, to input the prompt sentence to the generative AI model to cause the generative AI model to generate analysis result data indicating materials and procedures related to the audit check items, and to determine applicability of the audit check items based on the analysis result data; to structure the analysis result data to classify materials and procedures required for audit handling, and to generate and output instruction information that instructs preparation of the materials and execution of the procedures to a user terminal; to acquire progress information regarding a preparation status of the materials and an execution status of the procedures from the user terminal, to update the prompt sentence based on the progress information, to perform re-analysis by the generative AI model using the updated prompt sentence, and to extract additional materials and procedures required for the audit; to record the prompt sentence and the analysis result data as history information, and to automatically generate and update the audit check items based on the history information; and to recognize an emotional state of a user and generate advice information related to audit handling based on the emotional state and the analysis result data. This enables the server to algorithmically adapt audit requirements and guidance to a specific organization and its evolving preparation status, to iteratively refine audit check items and associated instructions using generative AI outputs and accumulated interaction history, and to adjust the form and content of guidance according to the user's emotional state, thereby improving the efficiency, relevance, and usability of computer-implemented audit support processing.

The term “system” refers to a combination of one or more hardware components and one or more software components that cooperate to execute processing related to audit support, including at least a processor and optionally one or more terminals and storage devices.

The term “processor” refers to one or more hardware processing units, such as a central processing unit, graphics processing unit, or dedicated accelerator, configured to execute machine-readable instructions for performing the functions described in the claims.

The term “organization data” refers to electronic data representing characteristics of an entity subject to audit, including at least attribute information and performance information of the entity.

The term “attribute information” refers to data that identifies general characteristics of an entity, such as industry category, size classification, applicable accounting standard, geographic region, and risk profile.

The term “performance information” refers to data representing financial or operational results of an entity over a period, including at least revenues, expenses, assets, liabilities, and other indicators relevant to audit assessment.

The term “audit process” refers to a sequence of audit-related activities for verifying the financial condition or performance of an entity, including planning, risk assessment, evidence collection, and conclusion stages.

The term “requirements to satisfy an audit process” refers to conditions, criteria, documents, procedures, and evidentiary elements that must be fulfilled so that an audit process conforms to predetermined standards or guidelines.

The term “audit check items” refers to audit-related evaluation points, verification items, or checklist entries used to determine whether particular aspects of an entity or its financial reports meet predetermined audit requirements.

The term “generative AI model” refers to a machine-learned model that receives input data including at least a prompt sentence and generates output data such as natural language text representing analysis results, recommendations, or synthesized audit information.

The term “prompt sentence” refers to natural language text or equivalent token data provided as input to a generative AI model to specify a task, context, or constraints for generation related to audit support.

The term “analysis result data” refers to data generated by a generative AI model in response to a prompt sentence, including at least information indicating materials and procedures related to audit check items.

The term “materials” refers to documents, records, datasets, or other evidentiary items that are to be prepared or collected for use in an audit process.

The term “procedures” refers to audit-related actions or operations to be performed, such as tests, confirmations, reconciliations, evaluations, or reviews, that support verification of audit check items.

The term “applicability of the audit check items” refers to an evaluation result indicating whether individual audit check items are relevant, required, optional, or not required for a particular entity or audit context.

The term “structure the analysis result data” refers to converting unstructured or semi-structured output from a generative AI model into a format with explicit fields, categories, or labels suitable for machine processing or presentation.

The term “instruction information” refers to data representing guidance to a user concerning preparation of materials and execution of procedures, including at least identifiers of items to be prepared or executed and their associated conditions or priorities.

The term “user terminal” refers to an information processing device operated by a user, such as a personal computer, mobile terminal, or other client device, that is capable of transmitting data to and receiving data from the system.

The term “progress information” refers to data indicating a current status of preparation of materials and execution of procedures, including at least whether each item is not started, in progress, or completed, and optionally including timestamps or evidence references.

The term “history information” refers to stored data representing past interactions and processing related to audit support, including at least past prompt sentences, analysis result data, determined applicability results, and previously generated audit check items.

The term “automatic generation and updating of the audit check items” refers to a process in which a processor, without manual creation or modification of each individual item by a human operator, creates or revises audit check items based on one or more of organization data, history information, and analysis result data.

The term “emotional state” refers to a psychological condition of a user, such as stress, anxiety, confidence, confusion, or satisfaction, inferred from input data including at least user interaction patterns, textual input, or biometric indicators.

The term “advice information” refers to data representing recommendations, explanations, encouragement, or other guidance provided to a user, the content or tone of which is at least partially determined based on the user's emotional state and analysis result data.

The term “audit handling” refers to overall operations performed by or for an entity in preparation for, or in execution of, an audit process, including preparation of materials, performance of procedures, and interaction with auditors.

The term “present in stages” refers to outputting information to a user terminal in a phased or stepwise manner, such that different sets of instruction information or advice information are provided at different times or in response to different conditions.

The term “dynamically change” refers to modifying instruction information or advice information during operation, based on updated inputs such as progress information, organization data, or emotional state, without requiring a complete system restart or static reconfiguration.

The term “reconstruct contents of the audit check items” refers to generating modified versions of audit check items, including adding, removing, merging, or reordering items, and changing their descriptions or conditions, based on updated context data using a generative AI model.

The term “re-analysis” refers to executing a generative AI model again using an updated prompt sentence or updated input context in order to obtain new or revised analysis result data.

In one embodiment, a server implements an audit-support system by executing a computer program stored in a non-transitory computer-readable storage medium. The server includes at least one central processing unit, an optional graphics processing unit, a main memory, a storage device, and a communication interface. The server operates under control of an operating system such as a general-purpose server operating system. The server communicates with one or more terminals via a communication network such as a packet-switched network using a protocol such as HTTP over TLS.

The server stores organization data in a structured data store such as a relational database management system. The server represents organization data in a data structure including attribute information fields and performance information fields. The server stores, as attribute information, values such as an industry category code, an entity size classification, an accounting standard identifier, and a risk profile indicator. The server stores, as performance information, time-series records of financial indicators such as revenue amounts, expense amounts, asset balances, and liability balances for each accounting period. The server associates the organization data with an organization identifier and an audit period identifier.

The server stores audit check items in a separate data structure. The server represents each audit check item by an item identifier, a natural-language description, a category label, a priority level, and an applicability flag. The server further stores history information indicating prior interactions with a generative AI model. The server represents the history information by records each including a prompt sentence, a corresponding analysis result, a timestamp, and links to the organization identifier and the audit check item identifiers involved.

The server executes a generative AI model that is implemented as a neural network. In one embodiment, the server uses a transformer-based neural network architecture that includes an input embedding layer, multiple self-attention layers, multiple feedforward layers, and an output language modeling head. The server stores the neural network parameters in a model file accessible from the main memory. The server loads the neural network parameters into the memory of the CPU or GPU at runtime.

The server prepares input to the generative AI model by constructing a prompt sentence. The server combines textual templates and variable fields derived from the organization data, the audit check items, and the progress information. For example, the server generates a prompt sentence such as:

“You are an audit expert. Based on the following information, generate a comprehensive list of required audit documents and procedures. Organization type: mid-sized manufacturing entity

Accounting standard: international financial reporting standard

Audit year: 2023

Audit check items: ‘Audit items related to the 2023 financial report.’

List all necessary audit documents and procedures needed to support an external audit.

Output the result as a bullet list, categorizing items into ‘Documents’ and ‘Procedures’. If a typical item is not applicable, state that it is not applicable and explain why.”

In another example, the server generates a prompt sentence such as:

“You are an audit expert. The following documents and procedures have already been prepared for the 2023 financial audit:

Prepared documents: financial statements, trial balance, internal control reports

Completed procedures: risk assessment of revenue recognition

Identify any additional documents or procedures that are typically required but are still missing. Output a bullet list under ‘Missing Documents’ and ‘Missing Procedures’ only.”

The server converts the prompt sentence into token identifiers using a tokenizer that maps characters or subword units to integers according to a vocabulary table. The server represents the token identifiers as a multi-dimensional tensor in main memory or GPU memory. The server passes the tensor through the neural network layers of the generative AI model. Each self-attention layer in the model computes, for each token position, a weighted combination of other token representations using query, key, and value matrices. The server performs matrix multiplications and non-linear activation functions such as rectified linear units in each feedforward layer. The server computes an output probability distribution over tokens for each time step using a softmax function.

The server samples or selects output tokens from the probability distribution according to generation parameters such as temperature, top-k, or top-p values. The server concatenates the selected tokens to form an output sequence. The server then converts the output token identifiers back into a text string. The server interprets the output text as analysis result data that includes lists of materials and procedures related to the audit check items.

The server structures the analysis result data by parsing the output text into internal data structures. The server identifies sections such as “Documents”, “Procedures”, “Missing Documents”, and “Missing Procedures” using rule-based pattern matching on headings and bullet markers. The server splits bullet list entries into individual items and assigns each item to a category. The server represents each item by a normalized name, a category label, and optional attributes such as “mandatory” or “recommended”. The server stores the structured analysis result data in the database linked to the corresponding audit request and organization.

The server determines applicability of the audit check items by combining the structured analysis result data with rule-based logic. The server stores applicability rules in a rule table that associates conditions on attribute information and performance information with applicability decisions. For example, the server may store a rule that an inventory valuation audit check item is applicable if the organization belongs to a manufacturing category and the performance information indicates inventory balances above a threshold. The server evaluates such rules against the organization data and the materials and procedures extracted from the analysis result data. The server sets the applicability flag of each audit check item according to the evaluation.

The server generates instruction information to be transmitted to a user terminal. The server generates natural-language text that enumerates required materials and procedures and indicates the priority and status of each item. The server may format the instruction information with hierarchical identifiers that link to the internal data structures for each material and procedure, enabling efficient update and tracking. The server transmits the instruction information as response data via the communication interface.

The terminal comprises a processor, a memory, an input device such as a keyboard or touch screen, a display, and a communication module. The terminal executes a client application such as a web browser or a native application. The terminal receives the instruction information from the server and renders it on the display as a checklist or a list view. The terminal allows the user to select items, enter comments, and update status such as “not started”, “in progress”, and “completed”.

The user operates the terminal to indicate completion of specific materials or procedures and, optionally, to upload associated files. The terminal sends progress information, including item identifiers and updated status fields, to the server. The server updates the progress information in the database and associates timestamps and links to any uploaded evidence files stored in a storage subsystem such as a network-attached storage or an object store.

The server uses the updated progress information to generate modified prompt sentences. The server incorporates the list of completed materials and procedures into the prompt sentence so that the generative AI model can focus on missing or insufficient items. The server thereby reduces unnecessary recomputation by constraining the generative output to new or remaining requirements. This controlled reuse of context data contributes to a reduction in communication data volume between the server and the terminal, because the server sends only incremental instruction updates instead of complete checklists in each response.

The server operates an emotion processing module that recognizes an emotional state of the user. In one embodiment, the server analyzes text input from the user, such as questions or comments entered in a free-text field in the client application. The server applies a separate neural network classifier trained for sentiment and emotion recognition. This classifier may be implemented as a transformer encoder that takes the user's text as input and outputs a probability distribution over emotional state categories such as “stressed”, “confident”, or “confused”. The server uses an error function such as cross-entropy during training of this classifier and updates network weights by gradient descent.

The server uses the detected emotional state to adapt the content and tone of advice information. For example, when the server recognizes a “stressed” emotional state, the server selects more explanatory and step-by-step advice templates and may simplify the technical detail of instructions. When the server recognizes a “confident” emotional state, the server may condense instructions and focus on higher-level summaries. The server thus modifies the advice information on the basis of model outputs and predefined mapping rules between emotional categories and advice styles. The server transmits the advice information along with the instruction information to the terminal.

The server achieves technical effects in the operation of the computer system. By using the organization data, the history information, and the progress information as explicit features in the prompt sentence generation and in the rule-based post-processing, the server reduces the number of redundant generative inference calls and the amount of unnecessary data generated and transmitted. This reduces processing time on the CPU or GPU and lowers bandwidth usage. Additionally, by structuring the analysis result data into machine-readable categories and identifiers, the server enables incremental updates and caching of partial results. The server can reuse previously generated materials and procedures for similar organizations or similar audit periods without rerunning full-scale generation, thereby improving computational efficiency.

The server improves accuracy of audit-relevant outputs compared to naive use of a generic generative AI model. The server constrains the model using prompt sentences that encode explicit audit-related context, organization-specific attributes, and standardized output formats. The server then applies deterministic rule-based validation and mapping from natural-language descriptions to standardized internal requirement codes. This hybrid architecture reduces hallucinations and misclassifications that may occur when using only generic language generation. Consequently, the server improves the precision of the materials and procedures lists and lowers the rate of omitted or irrelevant items.

The server also differs from manual human work in the way it processes and combines large volumes of structured and unstructured data. The server simultaneously considers multi-year performance data, detailed organization attributes, historical prompt-output pairs, and current progress status as inputs to the generative AI model and the rule-based modules. This multi-dimensional data fusion is not a simple automation of human reasoning but a computational process that uses high-dimensional vector representations and non-linear transformations in the neural network. The server uses loss functions and weight update rules tailored during training so that the model learns dependencies that are difficult to articulate as explicit human-written rules.

In another embodiment, the server employs a variant of the transformer architecture that incorporates additional attention heads specifically trained on audit-related tokens and phrase patterns. The server may further apply data augmentation during training by generating synthetic audit scenarios that vary organization size, industry, and risk profile while preserving logical consistency of audit requirements. Such training improves generalization of the generative AI model when applied to new organizations. The server also tunes model hyperparameters such as number of layers, hidden dimension size, and learning rate to balance response latency against generation quality in the target deployment environment.

In an alternative embodiment, the server partitions the model into separate encoder and decoder components and executes the encoder on an edge device while executing the decoder on a central server. In this configuration, the terminal performs initial feature extraction from user text or documents and transmits compact embeddings to the server instead of raw text.

This reduces communication load and enhances privacy, while the central server still performs the heavier generative decoding and rule-based post-processing. The server therefore achieves a distributed computation scheme with improved performance and reduced network usage.

The terminal may be implemented as a mobile terminal, a desktop terminal, or a thin-client terminal. The terminal can be configured to cache recent instruction information and advice information locally so that the user can continue to view guidance even when network connectivity is intermittent. When connectivity is restored, the terminal synchronizes updated progress information with the server. This architecture enables robust operation in environments with unstable communication conditions.

The user interacts with the system by reading instructions and advice on the terminal and by providing input data such as audit check item descriptions, comments, and completion status updates. The user does not need to manually construct complex audit checklists or interpret regulatory requirements. Instead, the user provides high-level audit objectives, and the server performs the computationally intensive tasks of generating, refining, and validating audit requirements. This division of labor allows the computer system to perform high-throughput, high-precision data analysis and recommendation, while the user focuses on decision-making and execution of physical tasks.

By configuring the server, the terminal, and the user interaction as described above, the system realizes an implementation form in which the generative AI model and the prompt sentence generation are deeply integrated with explicit data structures, rule-based control, and emotion-aware guidance. The server improves internal computer functions such as data management, inference efficiency, and output accuracy. The system thereby provides a concrete technical solution that extends beyond abstract information processing or mere business rule automation.

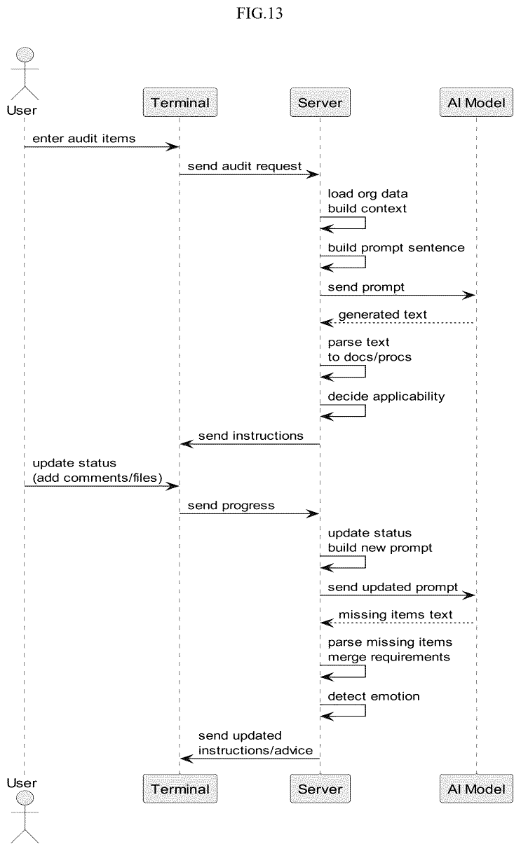

The following describes the processing flow using FIG. 13.

### Step 1

User operates the terminal to input audit requirements. User enters text such as “Audit items related to the 2023 financial report” into an input field of a client application. The input is human-readable text along with metadata such as organization identifier and audit year.

Terminal receives this input as character strings and converts it into an internal data structure including fields for user identifier, organization identifier, audit period, and audit check item text. Terminal transmits this structured data to the server via a network protocol as a request message. The input of this step is the user-entered audit requirement text and associated metadata, and the output is a structured electronic request sent from the terminal to the server.

### Step 2

Server receives the request message from the terminal through a communication interface. Server parses the message body to extract fields such as audit check item text, organization identifier, and audit period. Server performs validation by checking presence and format of each field and by verifying that the organization identifier exists in a data store. Server then writes the validated data into persistent storage as a record of an audit request. In this step, the input is the structured request from the terminal, and the output is a normalized and validated audit request record stored in a database.

### Step 3

Server accesses organization data associated with the organization identifier contained in the audit request record. Server reads attribute information such as industry category, size classification, and accounting standard from an organization table, and reads performance information such as revenues, assets, and liabilities from a financial data table. Server assembles these values into a context object that aggregates organization attributes, performance measures, and audit period. The input of this step is the organization identifier from the audit request, and the output is an organization context object containing attribute information and performance information.

### Step 4

Server generates a prompt sentence for a generative AI model based on the organization context and the audit check item text. Server loads a template that specifies an instruction role, output format, and explanatory constraints. Server replaces placeholders in the template with concrete values from the context object and the audit check item text. For example, server produces a prompt sentence such as: “You are an audit expert. Based on the following information, generate a comprehensive list of required audit documents and procedures.

Organization type: mid-sized manufacturing entity. Accounting standard: international financial reporting standard. Audit year: 2023. Audit check items: ‘Audit items related to the 2023 financial report.’ List all necessary audit documents and procedures needed to support an external audit. Output the result as a bullet list, categorizing items into ‘Documents’ and ‘Procedures’.” In this step, the input is the organization context and the audit check item text, and the output is a composed prompt sentence represented as a text string.

### Step 5

Server prepares model input data for the generative AI model by converting the prompt sentence into token identifiers. Server invokes a tokenizer that segments the prompt sentence into subword units and assigns an integer identifier to each unit according to a vocabulary.

Server aggregates these integer identifiers into an input sequence and stores the sequence in a tensor structure suitable for numerical computation on a processor. Server may also attach attention masks and special tokens to the sequence. The input of this step is the prompt sentence text, and the output is a set of numerical tensors representing tokenized input for the generative AI model.

### Step 6

Server executes the generative AI model using the tokenized prompt as input. Server loads a transformer-based neural network model into memory and transfers the input tensors to a compute device such as a graphics processing unit. Server performs a sequence of matrix multiplications, attention weight calculations, and non-linear activation operations layer by layer to compute contextual representations of the input tokens. Server then generates output token probabilities stepwise, using sampling rules such as top-p sampling to select successive output tokens until an end condition is met. The input of this step is the tokenized prompt tensors and generation parameters, and the output is a sequence of output token identifiers representing the generated text.

### Step 7

Server converts the sequence of output token identifiers back into text form and interprets the content as analysis result data. Server applies a decoding process that maps each integer identifier to a corresponding token string and concatenates the tokens into a readable sentence sequence. Server identifies sections and list items in the generated text by detecting labels such as “Documents:” and “Procedures:” and delimiters such as bullet markers. The input of this step is the output token identifiers generated by the neural network, and the output is a generated natural-language analysis result string that contains descriptions of audit materials and procedures.

### Step 8

Server structures the analysis result data into an internal representation for materials and procedures. Server parses the generated text line by line, extracts each bullet item, and assigns it to a category based on its preceding heading. Server normalizes item names, removes redundant characters, and assigns unique identifiers for each material and procedure. Server stores this structured representation in a data store with explicit fields for item type, description, category, and linkage to the originating audit request. In this step, the input is the unstructured analysis result text, and the output is a structured, machine-readable list of materials and procedures.

### Step 9

Server determines applicability of audit check items using the structured list of materials and procedures combined with organization data. Server applies rule-based logic that evaluates conditions on organization attributes and performance thresholds. For each audit check item, server examines whether relevant materials and procedures appear in the structured list and whether the organization satisfies predefined criteria for applicability. Server then marks each audit check item as applicable, optional, or not applicable. The input of this step is the structured materials and procedures list and the organization context, and the output is an updated set of audit check item records with applicability flags.

### Step 10

Server generates instruction information for the user based on the structured materials and procedures and the applicability decisions. Server composes human-readable instructions in which server lists required documents and required procedures, attaches applicability categories, and assigns priority levels. Server associates each instruction entry with internal identifiers used for tracking progress. Server then packs these instructions into a response message destined for the terminal. In this step, the input is the set of applicable materials and procedures and their metadata, and the output is a formatted instruction dataset ready to be transmitted to the terminal.

### Step 11

Terminal receives the instruction dataset from the server and renders it as a graphical user interface. Terminal parses the response message, constructs user interface elements such as lists and checkboxes, and displays each material and procedure with a label and status indicator. Terminal allows user interaction for marking completion status, adding notes, and selecting individual items. The input of this step is the instruction dataset from the server, and the output is a visible and interactive representation of audit preparation tasks on the display for the user.

### Step 12

User interacts with the terminal to update the status of materials and procedures and to input supplementary information. User marks items as “in progress” or “completed”, enters comments in text fields, and optionally attaches digital files corresponding to documents.

Terminal captures these actions and converts them into structured progress information consisting of item identifiers, status values, and optional attachments. Terminal then transmits the progress information to the server as update messages. The input of this step is the user's interactions on the interface, and the output is a set of structured progress updates and optional document data transmitted to the server.

### Step 13

Server receives progress information from the terminal and updates internal status records.

Server writes new status values, timestamps, and references to stored attachments into the database records associated with each material and procedure. Server then compiles an updated view of which items are complete, which are in progress, and which are not started.

The input of this step is the progress update messages from the terminal, and the output is an updated status model for all materials and procedures in persistent storage.

### Step 14

Server generates an updated prompt sentence to refine the analysis using the generative AI model, based on the progress information. Server includes in the prompt a list of completed documents and completed procedures and explicitly requests identification of missing items only. For example, server composes a prompt sentence such as: “You are an audit expert. The following documents and procedures have already been prepared for the 2023 financial audit:

Prepared documents: financial statements, trial balance, internal control reports. Completed procedures: risk assessment of revenue recognition. Identify any additional documents or procedures that are typically required but are still missing. Output a bullet list under ‘Missing Documents’ and ‘Missing Procedures’ only.” The input of this step is the current progress model, and the output is a new prompt sentence tailored to focus on remaining requirements.

### Step 15

Server repeats tokenization and generation with the generative AI model using the updated prompt sentence, and server obtains new analysis result data describing missing items. Server converts this new analysis result into structured lists of missing materials and missing procedures, merges these lists with the existing structured data, and marks newly identified items as not yet prepared. The input of this step is the updated prompt sentence and the current status model, and the output is an enriched data set that includes both completed and newly identified missing requirements.

### Step 16

Server operates an emotion processing module to recognize the user's emotional state from user-generated text or interaction patterns. Server receives input such as user comments or help requests and feeds this text into a classification model that outputs probabilities for emotion categories. Server converts these probabilities into a selected emotional state label.

Server then uses predetermined mapping rules to select advice style and content appropriate for the detected emotional state. The input of this step is user text or interaction-derived features, and the output is an emotional state label and corresponding advice parameters.

### Step 17

Server generates advice information that combines the emotional state and the current audit preparation status. Server selects explanatory templates and adjusts the level of detail according to the emotional state label. Server then fills these templates with concrete item references and action suggestions derived from the structured materials and procedures list and the progress information. Server appends this advice information to the instruction dataset and transmits the combined data to the terminal. The input of this step is the emotional state label and the structured preparation status, and the output is a set of personalized advice messages linked to audit tasks.

### Step 18

Terminal presents updated instructions and advice to the user and enables further iterative refinement. Terminal refreshes the user interface to highlight new missing items, display motivational or clarifying messages, and allow direct navigation to tasks requiring attention.

User can then continue the cycle of preparing documents, updating status, and submitting new comments. The input of this step is the updated instruction and advice dataset from the server, and the output is an updated interactive display and subsequent user interactions that drive further processing by the server.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented audit support systems mainly provide static checklists and simple rule-based validations. Such systems typically require human specialists to interpret large volumes of performance data and evolving regulation texts, to manually construct and maintain audit check items, and to manually coordinate preparation tasks across departments and physical resources. As a result, the underlying computer resources are used in a suboptimal way: processing pipelines are fragmented, data structures for audit knowledge are not consistently maintained, and user interaction is limited to rigid forms and dashboards that do not adapt to user state.

Further, existing systems generally separate audit logic, workflow orchestration, and user support functions. A first subsystem may retrieve financial data, a second subsystem may apply fixed compliance rules, and a third subsystem may handle notifications. These subsystems are loosely integrated and do not exploit modern machine learning models or generative models to structure and reorganize data flows. Consequently, the systems do not efficiently transform heterogeneous inputs such as internal performance information, external regulation information, robot execution feedback, and user interaction signals into a unified, machine-processable representation of audit knowledge. This leads to redundant data conversions, increased latency, and higher error rates in audit preparation.

Moreover, conventional audit tools lack mechanisms to automatically convert unstructured regulation texts into machine-readable audit check items and to keep those items synchronized with both external regulatory changes and internal performance changes. When regulation information changes, system administrators must manually review legal documents, update rule sets, and adjust data mappings. This manual updating process causes stale audit logic, increases the risk of non-compliance, and prevents computer systems from fully automating periodic re-evaluation of applicability across large item sets.

Additionally, current systems do not effectively integrate physical automation resources, such as robot control systems, into the logical audit workflow in a data-centric manner. Robot interactions, if present, are typically scripted separately and are not dynamically derived from a unified representation of audit preparation tasks. As a result, the computer cannot consistently translate high-level audit requirements and generated instructions into low-level commands, nor can it reliably feed robot execution results back into an audit task model. This fragmented integration limits end-to-end automation and hinders robust state management across digital and physical processes.

Furthermore, user support in conventional audit systems is largely static and ignores the emotional state of users who operate the system under time pressure and regulatory uncertainty. Even when sentiment analysis tools exist, they are usually bolted on as separate services and are not deeply integrated into the computation that governs audit task generation and prioritization. The computer therefore fails to adapt prompts, explanations, and guidance according to user state, and cannot use historical interaction logs to refine how it constructs prompts and decision conditions for the underlying models. This leads to inefficient human-computer interaction, reduced usability, and underutilization of available computational resources.

Accordingly, there is a need for a computer-implemented system that (i) unifies extraction, generation, applicability assessment, updating, and task orchestration of audit check items using a generative AI model and structured prompt sentences; (ii) automatically maps internal performance information and external regulation information into an integrated audit knowledge base; (iii) connects this knowledge base to a robot control system in a state-aware manner; and (iv) incorporates an emotion engine to adapt the generation and presentation of advice to the user. Such a system should improve the way processors organize memory structures, manage model prompts, and schedule computations, thereby increasing the efficiency, robustness, and adaptability of the underlying computer technology used for audit-related processing.

The specific processing by the specific processing unit 290 of the data processing device 12 in Application Example 2 is realized by the following means.

The present invention provides a server comprising a processor configured to determine audit requirements for verifying a financial condition based on performance information of an organization or an enterprise; to generate a prompt sentence for a generative AI model based on the audit requirements and attributes of the organization or the enterprise and to automatically generate audit check items by using the generative AI model in response to the prompt sentence; to associate the audit check items with the performance information, to determine in advance applicability of each audit check item by rule processing or machine learning processing, and to record a determination result and basis information for the applicability; to perform natural language processing on regulation information acquired from an external information source, to generate a further prompt sentence for the generative AI model based on a result of the natural language processing, to automatically update the audit check items by using the generative AI model in response to the further prompt sentence, and to manage differences before and after the update; to generate, based on the audit check items and the determination result of the applicability, an additional prompt sentence for the generative AI model and to generate specific preparation instructions regarding documents and procedures required for an audit by using the generative AI model in response to the additional prompt sentence, and to structure and record the preparation instructions as audit preparation tasks; to transmit, to a robot control system, instructions included in the audit preparation tasks that correspond to creation or transportation of physical materials, to acquire an execution result from the robot control system, and to update a progress state of the audit preparation tasks based on the execution result; to estimate an emotional state of a user based on image information, voice information, or text information acquired from a user terminal, to generate, by using an emotion engine and a further prompt sentence for the generative AI model, advice content corresponding to the audit preparation tasks and the emotional state by using the generative AI model in response to the further prompt sentence, and to present the advice content to the user; and to record log information relating to the audit check items, the determination result of the applicability, the audit preparation tasks, the execution result of the robot control system, and the advice content provided by the emotion engine, and to update at least one of a prompt sentence and a determination condition based on the log information. This enables the server to restructure and maintain audit-related data in unified machine-readable forms, to dynamically control generative and predictive models through optimized prompt sentences, to automatically propagate regulatory and performance changes through applicability assessments and physical workflows, and to adapt human-computer interaction based on user state, thereby improving the efficiency, reliability, and adaptability of the underlying computer technology used for audit processing.

The term “performance information” refers to machine-readable data representing operational or financial results of an organization or an enterprise, including at least one of revenue values, cost values, profit values, asset values, liability values, production quantities, or other quantitative business indicators.

The term “financial condition” refers to a state of economic health of an organization or an enterprise, expressed by aggregated numerical values and ratios derived from performance information, such as liquidity, solvency, profitability, and stability metrics.

The term “audit requirement” refers to a condition, rule, or criterion that must be satisfied in order to evaluate the financial condition or compliance status of an organization or an enterprise according to at least one audit standard or regulation.

The term “audit check item” refers to a discrete evaluation point or question, expressed in a machine-readable textual form, that specifies what aspect of the performance information or the business operation is to be examined to determine conformity with an audit requirement.

The term “applicability” refers to a logical relationship indicating whether a given audit check item is relevant and should be applied to a particular organization or enterprise under a given regulatory and operational context.

The term “generative AI model” refers to a machine learning model configured to generate textual or structured output data in response to input data, including at least one of a prompt sentence, context parameters, and additional structured features.

The term “prompt sentence” refers to a machine-readable text sequence that describes a task, context, or constraint and that is supplied as an input to a generative AI model in order to control or condition an output produced by the generative AI model.

The term “rule processing” refers to a computation process in which a processor applies predefined logical expressions, thresholds, or conditional statements to input data in order to produce a determination result.

The term “machine learning processing” refers to a computation process in which a processor applies a trained statistical model to input data in order to output a prediction, classification, or score based on patterns learned from training data.

The term “regulation information” refers to machine-readable data describing at least one of laws, standards, guidelines, or policies that govern financial reporting, security, privacy, or operational compliance of an organization or an enterprise.

The term “external information source” refers to a data providing system that is outside the system of the present invention and that supplies regulation information or other reference information through a communication interface such as an application programming interface.

The term “natural language processing” refers to automated operations executed by a processor to analyze, segment, classify, extract, or transform human language text into structured or semi-structured data.

The term “difference management” refers to recording, organizing, and associating changes between a previous version and an updated version of audit check items, including at least one of added items, modified items, and removed items.

The term “preparation instruction” refers to a generated specification of an operation needed for an audit, such as preparing a document, executing a procedure, or collecting evidence, expressed in a machine-readable format that can be assigned as a task.

The term “audit preparation task” refers to a structured data record that represents a unit of work derived from a preparation instruction, including at least a task description, a responsible entity, and a progress state.

The term “robot control system” refers to a control apparatus or software platform that receives commands from the processor and controls operation of at least one physical apparatus, such as a printing device or a transport mechanism, in order to execute physical actions.

The term “physical material” refers to a tangible object used for audit-related purposes, including at least one of printed documents, folders, or physical media that can be created, moved, or stored by a physical apparatus.

The term “user terminal” refers to an information processing device operated by a user, such as a portable communication device, a tablet device, or a personal computing device, that is configured to send and receive data to and from the server.

The term “image information” refers to digital image data acquired from an image sensor of a user terminal, including at least one frame that contains a representation of a user's face or other visual context.

The term “voice information” refers to digital audio data acquired from an audio input device of a user terminal and representing speech uttered by a user.

The term “text information” refers to character data input by a user through a user interface of a user terminal, including at least one of typed messages, selected options, or transcribed speech.

The term “emotional state” refers to a state of a user's affect, such as stress, anxiety, confidence, or confusion, estimated by a processor from at least one of image information, voice information, and text information.

The term “emotion engine” refers to a software component or set of software components that analyze at least one of image information, voice information, and text information to estimate an emotional state of a user and to generate or influence advice content based on the estimated emotional state.

The term “advice content” refers to machine-generated text or structured guidance that recommends at least one action or strategy to a user, wherein the guidance is related to audit preparation tasks and optionally adapted to the user's emotional state.

The term “log information” refers to data records that chronologically store details of system operations, including at least one of issued prompt sentences, generated audit check items, applicability determinations, task state changes, robot execution results, and advice content presented to the user.

The term “determination condition” refers to at least one parameter, threshold, rule, or model configuration used by the processor to compute a decision such as an applicability determination, and that can be updated based on log information or other feedback.

In one embodiment, a server executes a computer program that implements the claimed system. The server includes at least one processor, a memory, a non-volatile storage device, and a network interface. The processor executes software modules implemented, for example, in a general-purpose programming language such as Python running on an operating system such as a server-class operating system. The memory stores data structures representing performance information, audit requirements, audit check items, applicability results, audit preparation tasks, regulation information, user interaction logs, and model parameters. The server communicates with at least one user terminal over a communication network using a protocol such as HTTP, HTTPS, or a bidirectional protocol such as WebSocket. The user terminal comprises a computing device such as a portable communication device or a display device that includes a processor, a memory, a display unit, an image sensor, and an audio input device.

The server stores performance information of an organization or an enterprise in a relational database, for example using a database management system such as a relational database engine. The server issues structured query language (SQL) commands to retrieve performance information such as revenue data, cost data, profit data, asset data, liability data, and production quantity data. The server converts query results into in-memory tabular structures such as arrays or table objects (for example, data frames) and normalizes units, field names, and time indices. The server additionally stores regulation information in separate tables that contain regulation identifiers, jurisdiction codes, effective dates, and full-text segments of regulation articles.

The server uses a rule-based module to determine audit requirements based on the performance information. The server loads predetermined rule sets from a rule table or configuration file. Each rule defines conditions over performance features, for example, comparisons such as “annual revenue greater than threshold,” “number of subsidiaries greater than threshold,” or “presence of cross-border transactions.” The server computes feature vectors from the performance information by aggregating numerical fields over specified time windows and categories. The server applies these rule conditions using logical operations in the processor, and generates an internal representation of applicable audit requirements as entries in an audit requirement table. This structured computation improves consistency and speed over manual evaluation by ensuring that the same rule logic is applied identically each time new performance information is stored.

The server uses a generative AI model to generate audit check items from the determined audit requirements. In one embodiment, the server uses a sequence-to-sequence neural network implemented in a deep learning framework such as a numerical computation library. The neural network includes an encoder and a decoder. The encoder comprises multiple layers of attention-based units, each receiving as input tokenized representations of a prompt sentence and contextual metadata. The decoder comprises multiple layers of attention and feed-forward units configured to output token sequences representing audit check items. The server tokenizes the prompt sentence and associated metadata using a tokenizer module, encodes tokens into embedding vectors, and passes the vectors into the encoder. The decoder outputs token probabilities, from which the server derives audit check item text by greedy decoding or beam search.

The server constructs the prompt sentence to control the behavior of the generative AI model. The server includes in the prompt sentence at least (i) a summary of performance information, (ii) a description of organizational attributes such as industry and jurisdiction, and (iii) an instruction describing the desired output. For example, the server may generate the following prompt sentence:

“Using the following organization profile and financial indicators, generate a comprehensive list of audit check items to verify the organization's financial condition and compliance with applicable regulations.”

The server appends a machine-readable summary of the relevant performance indicators to this prompt sentence and submits the composite text to the generative AI model. The server receives a sequence of tokens representing one or more audit check items, parses delimiters such as numbering or bullet markers, and stores each item as a record in an audit check item table that includes fields for item identifier, textual description, category, source requirement, and generation timestamp.

The server determines applicability of each audit check item using both rule processing and machine learning processing. The server defines a feature mapping that converts performance information and audit check item metadata into numeric feature vectors. Each feature vector may include, for example, normalized financial ratios, indicator flags extracted from item text (such as the presence of terms related to “inventory” or “data protection”), and jurisdictional attributes. The server applies a classification model implemented as a neural network with multiple dense layers and non-linear activation functions. This network outputs an applicability score and a confidence value. The server compares the applicability score to a threshold and assigns a label such as “applicable,” “not applicable,” or “uncertain.” The server writes the label and the score into the audit check item table.

To enhance interpretability, the server optionally uses the generative AI model to generate a textual explanation for the applicability of each audit check item. The server constructs a prompt sentence such as:

“Given the following company data and the following audit check item, determine whether this item is applicable and explain the reasoning in a concise manner.”

The server inserts the structured company data and the text of the audit check item into the prompt sentence and transmits the combined text to the generative AI model. The server receives a textual output containing both a decision and an explanation, parses these components, and stores the explanation in an explanation field associated with the audit check item. By combining structured classification with generative justification, the server improves the technical transparency of applicability decisions, which assists in debugging and in subsequent refinement of rules and model parameters.

The server maintains audit check items in synchronization with regulation information received from an external information source. The server periodically retrieves regulation information through a communication interface, for example by using an application programming interface that returns regulation texts in a structured format. The server stores received regulation texts as records in a regulation text table and indexes them by jurisdiction and topic. The server performs natural language processing on the regulation texts, including tokenization, part-of-speech tagging, and segmentation into requirement-like sentences. The server constructs a prompt sentence such as:

“Extract all audit-relevant requirements and changes from the following regulation text, and summarize them as discrete audit requirements suitable for generating audit check items.”

The server sends the regulation segment along with the prompt sentence to the generative AI model, receives a structured list of extracted requirements, and aligns each extracted requirement with existing audit check items. When no corresponding item exists, the server creates a new audit check item record. When a corresponding item is present but the regulatory content has changed, the server updates the text or metadata of the existing item and records version information and differences. This automatic mapping from regulation text to audit data structures reduces manual rule maintenance and increases update frequency, thereby improving the timeliness and accuracy of the audit logic implemented by the computer system.

The server generates preparation instructions from the audit check items and applicability results. The server aggregates all applicable audit check items and builds a context representation that includes item text, associated requirements, and estimated risk levels. The server composes a prompt sentence such as:

“Analyze the following list of applicable audit check items and generate a detailed list of required documents and procedures, including a short description, a responsible role, and a suggested due date for each element.”

The server transmits the prompt sentence with the checklist to the generative AI model and receives a textual or semi-structured description of tasks. The server parses the description into audit preparation tasks with fields such as task description, responsible entity, linked audit item identifiers, and default status. The server stores these tasks in a preparation task table and maintains their progress status. By structuring preparation instructions into discrete tasks, the server enables programmatic control and monitoring of audit preparation inside the database and in memory, which improves the ability of the computer to manage concurrent tasks and to synchronize their status with external resources.

The server integrates a robot control system into the audit preparation flow to handle physical materials. In one embodiment, the server uses a robot middleware platform that implements a publish-subscribe communication model. The server converts relevant audit preparation tasks into command messages that include operation type (such as print, fetch, or deliver), document identifiers, and target locations. The server publishes these messages on communication channels that the robot control system subscribes to. The robot control system interprets these commands and controls physical actuators, such as printing devices and movement mechanisms, to create and move physical materials. The robot control system returns execution status messages, including success or error codes, which the server receives and processes. The server updates the corresponding preparation task entries with completion timestamps and error details. This tightly-coupled interaction between digital task structures and physical actuation improves the efficiency and reliability of end-to-end audit preparation, and reduces the need for manual confirmation of physical document handling.

The user interacts with the system through the user terminal. The user terminal displays lists of audit check items, applicability labels, and preparation tasks received from the server through web service calls or real-time channels. The user may filter items, request explanations, or modify applicability labels. The user terminal transmits such user actions as structured requests to the server. The user terminal also captures image information of the user's face using the image sensor, and captures voice information using the audio input device, upon explicit user consent. The user terminal transmits either raw media data or features extracted by local pre-processing modules to the server.

The server implements an emotion engine to estimate the user's emotional state and to adapt the generation of advice content. The server applies image processing techniques, for example using a computer vision library, to detect a face in the image information and to extract facial landmarks. The server computes expression features such as mouth openness, eyebrow position, and eye region shape. The server optionally applies a convolutional neural network trained on labeled facial expression images to output a probability distribution over emotional categories such as stress, calmness, confusion, or confidence. For voice information, the server computes acoustic features such as pitch, energy, and spectral coefficients and applies a recurrent or attention-based neural network trained on speech emotion datasets. For text information, the server tokenizes user messages and applies a text classification model to infer sentiment or intent. The server fuses outputs from these modalities to derive a combined emotional state.

The server uses the estimated emotional state and current audit preparation tasks to generate tailored advice content. The server constructs a prompt sentence such as: “The user currently exhibits signs of stress and confusion regarding audit preparation. Based on the following list of audit preparation tasks, generate brief, practical advice to reduce stress and clarify which tasks should be handled first.”

The server passes the emotional state and task context in encoded form into the prompt sentence and transmits it to the generative AI model. The server receives a textual advice message and may post-process it to conform to length and style constraints. The server transmits the advice content to the user terminal, which displays it as an overlay or notification. By adjusting advice content dynamically according to a multi-modal emotional state estimation, the system reduces cognitive load and guides the user toward prioritized actions. This adaptation is based on explicit technical processing of sensor data and model outputs, and not merely on business rules.

The server records log information for key entities and operations. The server logs, in storage, each prompt sentence, generative AI model output, applicability determination, regulation update mapping, robot command, robot execution result, emotion estimation, and advice content. Each log record includes timestamps, identifiers of data entities involved, and model configuration identifiers. The server analyzes the log information using statistical methods and, in some embodiments, machine learning techniques to detect patterns such as recurring explanation requests for certain types of audit items or frequent user overrides of applicability labels. The server then modifies parameters in the rule-based module, thresholds used in applicability classification, and structures of prompt sentences to improve model behavior.

For example, when the server observes that generated audit check items are frequently too general for a particular jurisdiction, the server updates the prompt template to include more detailed jurisdictional constraints, such as:

“Considering that the jurisdiction is a specific country and that the organization is in a specific industry, generate concise and jurisdiction-specific audit check items aligned with local accounting standards.”

By updating prompt sentences based on empirical log data and by adjusting model hyperparameters or rule sets, the server improves the accuracy and stability of the generative AI model outputs. This feedback loop constitutes a technical optimization process that refines the functioning of the computer system as a whole, rather than merely automating human drafting of checklists.

The described architecture and data flows provide technical effects beyond simple automation of human audit activities. The server reduces redundant data conversions by maintaining unified, structured representations for requirements, items, tasks, and logs in a single relational schema. This unification enables the processor to perform fewer join operations and to cache commonly used aggregates, which improves processing speed when recalculating applicability or regenerating preparation instructions. The combination of rule-based classification and neural-network-based classification reduces misclassification error by capturing both explicit domain rules and complex patterns in the data. The server's use of machine-readable prompt sentences as configurable control inputs for the generative AI model allows dynamic reconfiguration of generation behavior without redeploying model binaries, which shortens adaptation time and reduces operational overhead.

In addition, the integration of robot control into the audit preparation task model reduces communication overhead and state synchronization errors. Because the server maps preparation tasks directly to robot commands and receives execution status in a structured format, the system avoids manual re-entry of task completion and enables automated reconciliation between digital and physical states. This leads to fewer inconsistencies, reduced human error, and improved throughput in document handling processes.

The emotion engine improves human-computer interaction efficiency by filtering and prioritizing information based on user state. When the server detects high stress or confusion, the server generates shorter, more focused advice messages and hides less urgent information from the main view. This selective presentation reduces display clutter and cognitive processing requirements for the user, allowing faster and more accurate responses. The adaptation is computed using specific signal-processing and neural-network-based modules, and the resulting changes in interface behavior are driven by objective estimations of emotional state.

Multiple variations are possible within the scope of the claims. The server may employ different neural network architectures for the generative AI model, such as a recurrent neural network or a convolutional sequence model, and may use different training regimes, such as supervised fine-tuning on domain-specific audit data or reinforcement learning from human feedback. The applicability classifier may be implemented as a gradient-boosted decision tree model instead of a neural network in certain embodiments. The emotion engine may rely solely on text-based sentiment analysis when image or voice information is unavailable. The robot control system may control different types of physical apparatus, such as mobile platforms, robotic arms, or automated storage and retrieval systems. The user terminal may be any computing device equipped with a display and communication capabilities. These variations still rely on the same core data structures and processing patterns described herein and continue to provide the technical advantages of improved data management, model control, and device integration achieved by the claimed system.

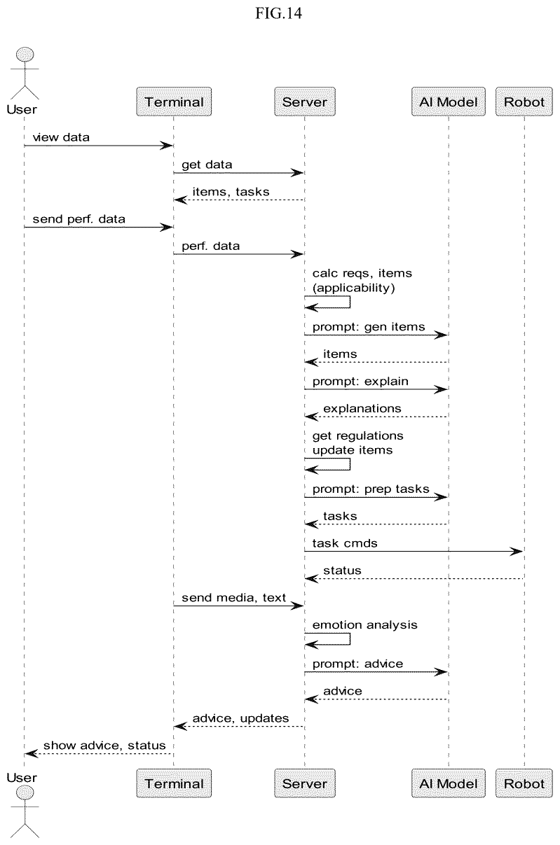

The following describes the processing flow using FIG. 14.

### Step 1

The server acquires performance information of an organization or an enterprise.

The server receives, as input, database connection information and query parameters specifying a time range and data categories such as revenue, cost, and production. The server issues SQL queries to a relational database, retrieves result tables, and converts the tables into in-memory data structures such as arrays or table objects. The server normalizes units (for example, converting all currency values to a reference currency), aligns time indices (for example, by quarter), and stores the processed performance information in a performance data repository as output.

### Step 2

The server determines audit requirements based on the performance information.

The server receives, as input, the normalized performance information and rule definitions stored in a rule configuration repository. The server computes derived indicators such as annual revenue, number of employees, and number of foreign subsidiaries by aggregating the performance information. The server applies rule conditions (for example, revenue>threshold AND foreign operations=true) to these indicators, and outputs a list of applicable audit requirements, each tagged with a requirement identifier and associated conditions, storing them in an audit requirement table.

### Step 3

The server generates a prompt sentence for a generative AI model from the audit requirements and organizational attributes.

The server receives, as input, the list of applicable audit requirements and organizational attributes such as industry, jurisdiction, and legal form. The server concatenates a natural-language description of these inputs into a structured prompt sentence, for example: “Using the following organization profile and financial indicators, generate a comprehensive list of audit check items to verify the organization's financial condition and compliance with applicable regulations.” The server appends a machine-readable summary of the requirements and attributes, and outputs the completed prompt sentence as a text string ready for submission to the generative AI model.

### Step 4

The server calls the generative AI model to generate audit check items.

The server receives, as input, the prompt sentence produced in Step 3. The server tokenizes the prompt sentence, encodes the tokens into numerical embeddings, and sends these embeddings to the generative AI model via a model inference interface. The generative AI model processes the embeddings and outputs token probabilities, which the server decodes into a textual response consisting of multiple audit check items. The server parses the response to split it into individual items, extracts the text of each item, and outputs a structured list of audit check items, storing them in an audit check item table with identifiers and categories.

### Step 5

The server associates audit check items with performance information and determines applicability.

The server receives, as input, the structured list of audit check items from Step 4 and the performance information from Step 1. The server maps each audit check item to relevant performance features by analyzing keywords in the item text (for example, “inventory,” “receivables,” “data protection”) and linking them to corresponding data fields. The server builds feature vectors that combine item metadata and performance indicators. The server then applies rule processing and, optionally, a machine learning classifier to compute an applicability score for each item. The server compares the score to predefined thresholds and outputs, for each audit check item, an applicability label (“applicable,” “not applicable,” or “uncertain”) and a confidence value, which are stored back into the audit check item table.

### Step 6

The server generates explanations for applicability decisions using a generative AI model.

The server receives, as input, the audit check items, their applicability labels, the associated performance information, and a template prompt sentence such as: “Given the following company data and the following audit check item, determine whether this item is applicable and explain the reasoning in a concise manner.” For each item, the server fills the template with the relevant data and item text to form a new prompt sentence. The server sends this prompt sentence to the generative AI model, receives a textual explanation, and parses the explanation to extract a reasoning segment. The server outputs and stores the explanation in an explanation field linked to the corresponding audit check item.

### Step 7

The server acquires regulation information from an external information source and processes it.

The server receives, as input, API endpoint information and authentication credentials for an external regulation information provider. The server sends API requests, obtains JSON or text payloads containing regulation texts, and stores the raw texts in a regulation data repository.

The server then applies natural language processing (tokenization, sentence segmentation) to the regulation texts and outputs segmented regulation units (for example, articles or clauses) with identifiers, saving them in a regulation segment table.

### Step 8

The server extracts audit-relevant requirements from regulation information using a generative AI model.

The server receives, as input, regulation segments from Step 7 and a template prompt sentence such as: “Extract all audit-relevant requirements and changes from the following regulation text, and summarize them as discrete audit requirements suitable for generating audit check items.” The server creates a full prompt sentence by combining the template with each regulation segment, and sends the prompt sentence to the generative AI model. The server receives a textual list of extracted requirements, parses the list into discrete requirement entries, and outputs structured requirement records with fields such as description, type of change, and related topic, which are stored in a regulation requirement table.

### Step 9

The server updates audit check items based on extracted regulation requirements and manages differences.

The server receives, as input, the extracted regulation requirements from Step 8 and the existing audit check items from the audit check item table. The server performs a matching operation by comparing textual similarity and topic labels between each regulation requirement and existing audit check items. When no match is found, the server creates a new audit check item; when a match is found but the regulation requirement text has changed, the server modifies the corresponding audit check item text and metadata. The server records the previous and updated versions in a version history table and outputs an updated set of audit check items with change annotations.

### Step 10

The server generates preparation instructions for documents and procedures required for an audit.

The server receives, as input, the updated and applicable audit check items and their applicability labels from previous steps. The server aggregates all items labeled “applicable” and constructs a context description. The server composes a prompt sentence such as:

“Analyze the following list of applicable audit check items and generate a detailed list of required documents and procedures, including a short description, a responsible role, and a suggested due date for each element.” The server sends this prompt sentence and the list of items to the generative AI model and receives a textual output describing preparation steps.

The server parses this output into structured preparation instructions and outputs audit preparation tasks containing task descriptions, responsible entities, and suggested deadlines, storing them in a preparation task table.

### Step 11

The server interacts with a robot control system to execute tasks involving physical materials.

The server receives, as input, the audit preparation tasks from Step 10 and a mapping that indicates which tasks involve physical actions such as printing or delivery. The server converts such tasks into robot command messages that include operation type, document identifiers, and destination locations. The server publishes these messages to a robot control system over a communication channel. The robot control system executes physical operations and returns status messages (success, failure, error codes). The server receives these status messages, updates the corresponding task records with completion status and timestamps, and outputs updated task states for use by user terminals.

### Step 12

The terminal presents audit check items, applicability results, and preparation tasks to the user.

The terminal receives, as input, structured data from the server via an application programming interface, including lists of audit check items with applicability labels, explanations, and audit preparation tasks with progress states. The terminal renders this data as tables and dashboards on a display unit. The terminal provides user interface controls allowing the user to filter items, view explanations, mark tasks as completed, or override applicability. When the user performs an action, the terminal creates a corresponding request message and transmits it to the server. The terminal outputs a visual representation of the latest system state to the user.

### Step 13

The user reviews information, provides feedback, and optionally overrides system decisions. The user receives, as input, the displayed audit check items, explanations, and task lists on the terminal screen. The user may click on an item to read the applicability explanation or may change an applicability label from “applicable” to “not applicable” or vice versa. The user may enter comments or ratings of usefulness into text fields. The user's actions produce input events that the terminal encodes as structured messages and sends to the server. The user thus outputs feedback and override instructions that influence future system processing.

### Step 14

The terminal captures user image, voice, and text information for emotion analysis.

The terminal receives, as input, user consent to activate emotion-related features. The terminal activates the image sensor and audio input device and captures frames of the user's face and segments of the user's speech while the user interacts with audit interfaces. The terminal may optionally perform pre-processing such as downscaling images or extracting audio features. The terminal bundles media data or extracted features with session identifiers and transmits them to the server. The terminal also captures text typed by the user into chat or comment interfaces and outputs this text to the server for further analysis.

### Step 15

The server estimates the user's emotional state using an emotion engine.

The server receives, as input, image information, voice information, and text information from Step 14. The server applies facial detection and feature extraction algorithms to the image information, computes acoustic features from the voice information, and tokenizes the text information. The server feeds these features into modality-specific classifiers (for example, convolutional or recurrent neural networks) and obtains probability distributions over emotional categories. The server fuses these distributions using a weighting scheme to derive a combined emotional state indicator such as “high stress” or “moderate confusion.”

The server outputs the estimated emotional state and stores it with a timestamp and session identifier.

### Step 16

The server generates advice content tailored to the emotional state and current tasks using a generative AI model.

The server receives, as input, the estimated emotional state from Step 15 and the current list of audit preparation tasks from Step 10 or Step 11. The server constructs a prompt sentence such as: “The user currently exhibits signs of stress and confusion regarding audit preparation. Based on the following list of audit preparation tasks, generate brief, practical advice to reduce stress and clarify which tasks should be handled first.” The server appends a representation of the emotional state and the task list to this prompt sentence and sends it to the generative AI model. The server receives textual advice content, optionally truncates or formats it, and outputs the advice content as a string.

### Step 17

The terminal displays the advice content and updated status to the user.

The terminal receives, as input, the advice content from Step 16 and any updated task or item status from the server. The terminal displays the advice content prominently, for example as a notification or guidance panel, and updates task views to reflect any changes. The terminal allows the user to acknowledge the advice or indicate whether it was helpful. The terminal outputs additional feedback messages to the server based on the user's responses.

### Step 18

The server logs system operations and refines prompt sentences and determination conditions.

The server receives, as input, events generated during all previous steps, including prompt sentences sent to the generative AI model, model outputs, applicability determinations, regulation updates, robot execution results, emotional state estimations, advice content, and user feedback. The server writes these events into log tables with structured fields for time, context identifiers, and outcome metrics. The server analyzes the log data by computing statistics such as error rates, override frequencies, and user satisfaction scores. Based on this analysis, the server modifies parameters in rule processing, adjusts thresholds in applicability classifiers, and edits templates for prompt sentences (for example, adding jurisdiction-specific constraints). The server outputs updated configuration data and prompt templates, which are used in subsequent invocations of previous steps to improve processing accuracy, speed, and robustness.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

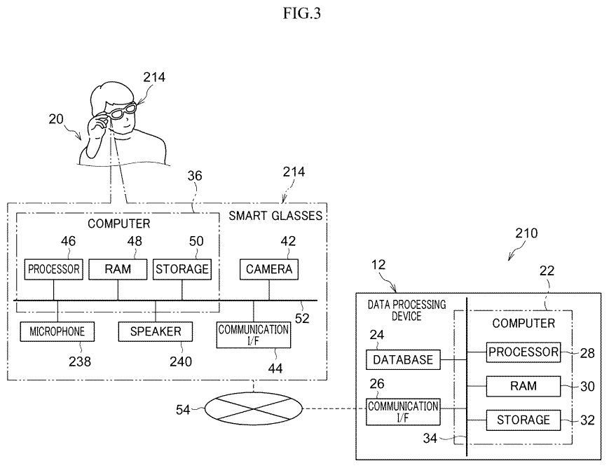

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

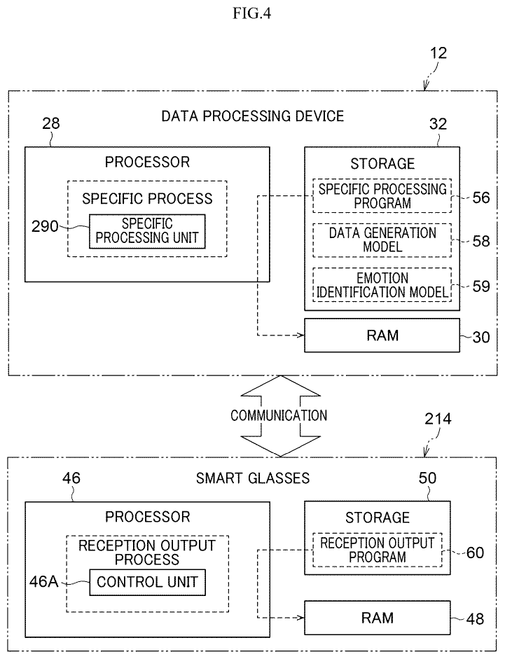

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

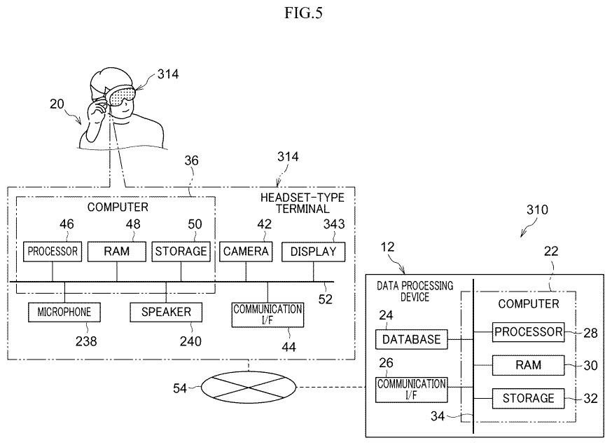

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

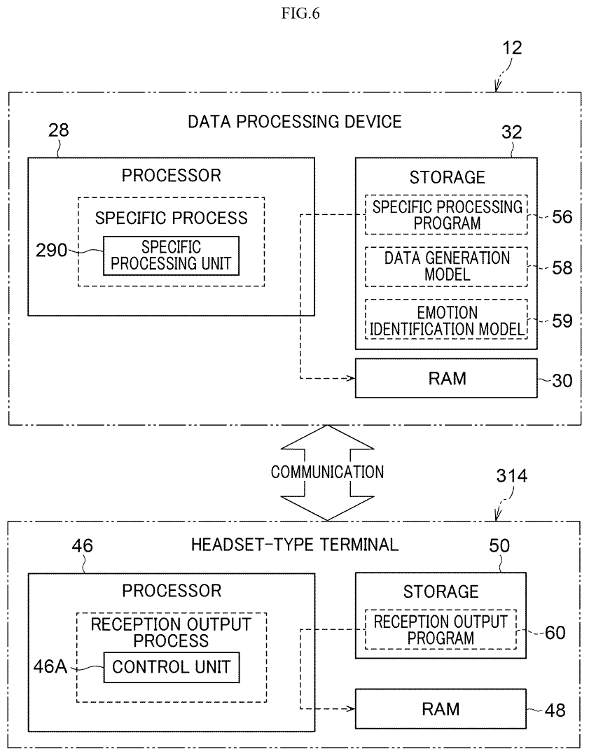

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

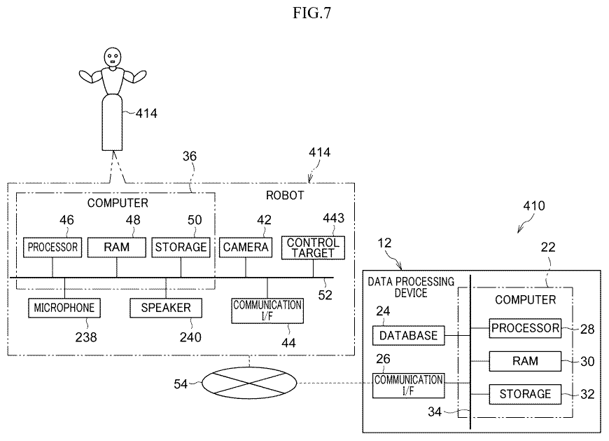

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

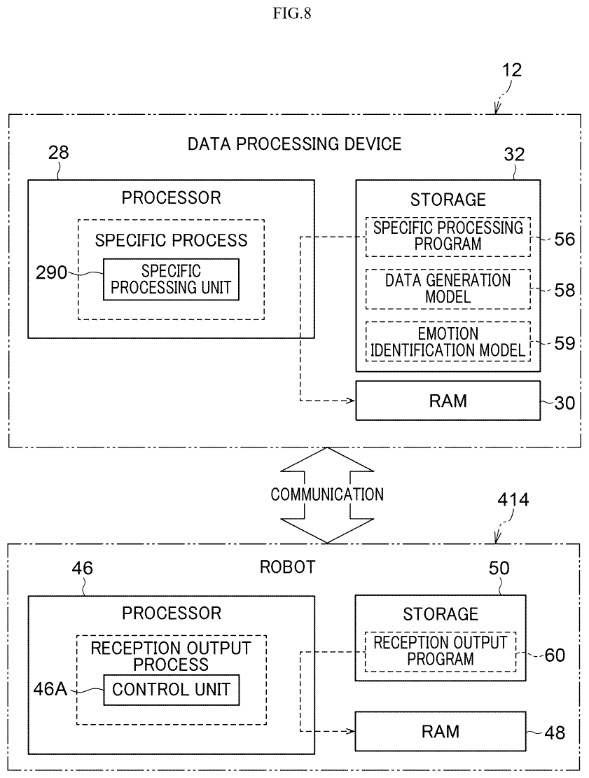

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

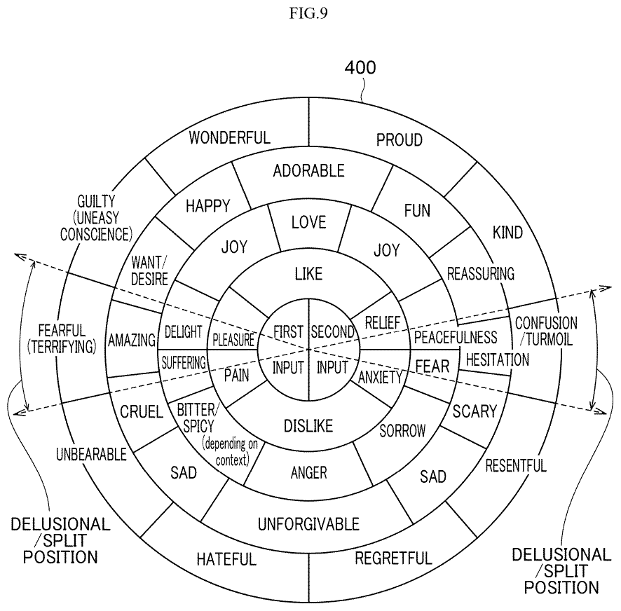

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

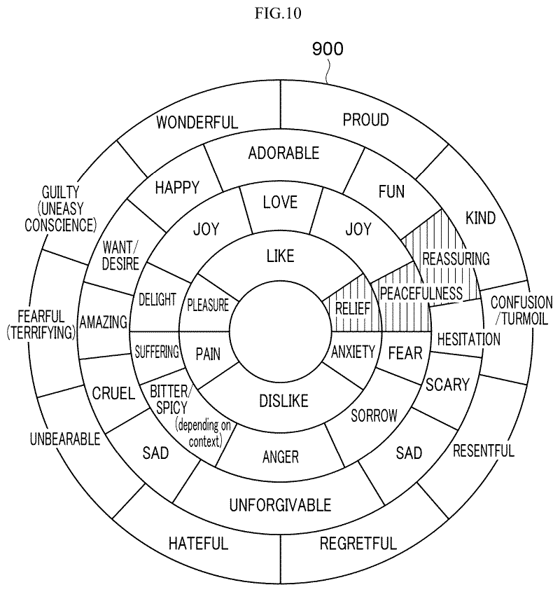

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire performance information of an organization or an enterprise, verify a structure and a format of the performance information, detect missing values and inconsistencies in the performance information, and convert the performance information into an analysis-ready format,
generate, based on the analysis-ready performance information and a prompt sentence input by a user, audit check item candidates in a natural language by using a generative AI model, and automatically construct context information to be input to the generative AI model,
compare the audit check item candidates with audit standard information and regulation information stored in a reference information storage unit, determine applicability and an application degree of the audit check item candidates, and extract applicable audit check items,
present the applicable audit check items to the user via a display device, and acquire, as feedback information, correction content, evaluation information, and comment information provided by the user with respect to the applicable audit check items,
generate training data based on a correspondence between the feedback information and the prompt sentence and the context information, and update parameters of the generative AI model so as to continuously improve the generative AI model, and
record a generation history of the audit check items, applicability determination results, and the feedback information in a storage device, and accumulate the recorded information as reusable audit knowledge for future audit responses.

### Supplementary 2

The system according to supplementary 1,
wherein the processor is configured to
cause the generative AI model to receive, as an input text sequence, the prompt sentence and summary information extracted from the performance information, output a plurality of the audit check item candidates, and automatically add the summary information to the input text sequence so as to construct context that indicates an audit target period, an account category, and an abnormal tendency.

### Supplementary 3

The system according to supplementary 1,
wherein the processor is configured to
adjust, based on the feedback information, template information of the prompt sentence and generation rules of the context information in addition to updating weight parameters of the generative AI model, and control the generative AI model such that specificity of subsequently generated audit check items and a degree of conformity of the subsequently generated audit check items to a user preference are increased.

### Application Example 1

### Supplementary 1

A system comprising a processor, a storage device, a communication interface, and a terminal,
wherein the processor is configured to
acquire performance information related to an organization or an enterprise via the communication interface, and perform preprocessing on the performance information including correction of missing values, unification of formats, and normalization of numerical indicators, and store the preprocessed information in the storage device, confirm requirements in an audit process based on the preprocessed information, and
calculate audit evaluation indicators used for verification of a financial situation, generate a prompt sentence including an instruction relating to the requirements and the audit evaluation indicators, or acquire the prompt sentence input from the terminal,
input the prompt sentence and the audit evaluation indicators to a generative information processing model that is a generative AI model, and cause the generative information processing model to generate response information including audit check items and applicability conditions corresponding to the audit check items,
analyze the response information and extract the audit check items and the applicability conditions as structured data,
compare the applicability conditions with the audit evaluation indicators, determine applicability and priority for each of the audit check items, and add determination results to the structured data,
record the structured data and the determination results in the storage device as record information, and append identification information and time information to the record information to maintain the record information as history,
generate delivery information including the audit check items and the determination results in a form displayable or presentable by the terminal, and transmit the delivery information to the terminal via the communication interface,
acquire, from the terminal, evaluation information including applicability, implementation status, or comments by a user regarding the audit check items, and additionally store the evaluation information in the storage device as part of the record information,
generate a new prompt sentence based on the evaluation information and a history of the prompt sentences, and update contents of subsequent inquiries to the generative information processing model,
and recognize an emotional state of the user, generate advisory information according to the emotional state and the determination results of the audit check items, and provide the advisory information to the terminal using an emotion processing function.

### Supplementary 2

The system according to supplementary 1,
wherein the processor is configured to cause the terminal to display the audit check items and the determination results included in the delivery information, receive an input operation or a voice operation from the user via the terminal, generate the evaluation information based on the input operation or the voice operation, and transmit the evaluation information to the processor via the communication interface.

### Supplementary 3

The system according to supplementary 1,
wherein the processor is configured to update contents of the audit check items and criteria for determining the applicability based on the response information acquired from the generative information processing model and the evaluation information, and to provide the updated audit check items again to the terminal as the delivery information.

### Example 2

### Supplementary 1

A system comprising a processor,
wherein the processor is configured to
confirm requirements to satisfy an audit process on the basis of organization data including attribute information and performance information related to an organization,
generate a prompt sentence to be input to a generative AI model on the basis of the organization data and audit check items, input the prompt sentence to the generative AI model to cause the generative AI model to generate analysis result data indicating materials and procedures related to the audit check items, and determine applicability of the audit check items on the basis of the analysis result data,
structure the analysis result data to classify materials and procedures required for an audit and generate and output instruction information that instructs preparation of the materials and execution of the procedures to a user terminal,
acquire progress information regarding a preparation status of the materials and an execution status of the procedures from the user terminal, update the prompt sentence on the basis of the progress information, perform re-analysis by the generative AI model using the updated prompt sentence, and extract additional materials and procedures required for the audit, record the prompt sentence and the analysis result data as history information, and perform automatic generation and updating of the audit check items on the basis of the history information, and
recognize an emotional state of a user and generate advice information related to audit handling on the basis of the emotional state and the analysis result data.

### Supplementary 2

The system according to supplementary 1,
wherein the processor is configured to
present the instruction information and the advice information regarding the materials and the procedures required for audit handling to the user terminal in stages, and dynamically change the instruction information and the advice information in accordance with the progress information.

### Supplementary 3

The system according to supplementary 1,
wherein the processor is configured to
reconstruct contents of the audit check items on the basis of the organization data, the history information, and the progress information by using the generative AI model, and
automatically perform the determination of the applicability and the extraction of the materials and the procedures for each reconstructed audit check item.

### Application Example 2

### Supplementary 1

A system comprising a processor,
wherein the processor is configured to
determine audit requirements for verifying a financial condition based on performance information of an organization or an enterprise,
generate a prompt sentence for a generative AI model based on the audit requirements and attributes of the organization or the enterprise, and automatically generate audit check items by using the generative AI model in response to the prompt sentence,
associate the audit check items with the performance information, determine in advance applicability of each audit check item by rule processing or machine learning processing, and record a determination result and basis information for the applicability,
perform natural language processing on regulation information acquired from an external information source, generate a prompt sentence for the generative AI model based on a result of the natural language processing, automatically update the audit check items by using the generative AI model in response to the prompt sentence, and manage differences before and after the update,
generate, based on the audit check items and the determination result of the applicability, a prompt sentence for the generative AI model and generate specific preparation instructions regarding documents and procedures required for an audit by using the generative AI model in response to the prompt sentence, and structure and record the preparation instructions as audit preparation tasks,
transmit, to a robot control system, instructions included in the audit preparation tasks that correspond to creation or transportation of physical materials, acquire an execution result from the robot control system, and update a progress state of the audit preparation tasks based on the execution result,
estimate an emotional state of a user based on image information, voice information, or text information acquired from a user terminal, generate, by using an emotion engine and a prompt sentence for the generative AI model, advice content corresponding to the audit preparation tasks and the emotional state by using the generative AI model in response to the prompt sentence, and present the advice content to the user, and
record log information relating to the audit check items, the determination result of the applicability, the audit preparation tasks, the execution result of the robot control system, and the advice content provided by the emotion engine, and update at least one of the prompt sentence and a determination condition based on the log information.

### Supplementary 2

The system according to supplementary 1,
wherein the processor is configured to continuously monitor the audit check items, the determination result of the applicability, and the progress state of the audit preparation tasks, determine arrival of a timing for executing an audit when the audit preparation tasks satisfy a predetermined condition, and notify the user of a result of the determination.

### Supplementary 3

The system according to supplementary 1,
wherein the processor is configured to dynamically change the prompt sentence for the generative AI model in accordance with the regulation information acquired from the external information source and latest performance information of the organization or the enterprise, and automatically update content of the audit check items and criteria for determining the applicability based on the prompt sentence.

What is claimed is:

1. A system comprising:
circuitry configured to:
receive, via a communication interface coupled to a packet-switched network, structured performance data from a terminal device, the structured performance data representing operational conditions of an organization;
verify a structure and format of the structured performance data, detect missing values and inconsistencies, and convert the structured performance data into an analysis-ready format;
construct context information for input to a generative neural network model by aggregating features derived from the analysis-ready format, the context information comprising at least a target period indicator, a category identifier, and an anomaly tendency indicator;
generate, using the generative neural network model and the context information, a plurality of check item candidates in natural language;
score each check item candidate against condition data stored in a storage device to compute an applicability score, and extract check items for which the applicability score satisfies a threshold;
transmit the extracted check items to the terminal device via the communication interface;
receive feedback information from the terminal device comprising user-provided corrections and evaluation data with respect to the extracted check items, and update parameters of the generative neural network model using training data constructed from the feedback information and the context information; and
estimate an emotional state of a user based on input signals received from the terminal device, and generate advice content adapted to the estimated emotional state using the generative neural network model.

2. The system according to claim 1, wherein the circuitry is configured to verify the structured performance data by checking required field presence, data type conformance, and value range constraints, and to impute missing values using a statistical measure of corresponding fields or flag non-imputable records for exclusion.

3. The system according to claim 2, wherein the circuitry is configured to convert the structured performance data into the analysis-ready format by normalizing numerical values, harmonizing categorical codes using a reference mapping table, and aligning time period representations to a standardized schema.

4. The system according to claim 3, wherein the structured performance data comprises financial transaction records of the organization, the target period indicator identifies a fiscal reporting period, and the anomaly tendency indicator is derived by computing variance of expense categories relative to a historical baseline.

5. The system according to claim 4, wherein the circuitry is configured to construct the context information by tokenizing a user-provided prompt string and concatenating the tokenized prompt string with a textual summary of aggregated features derived from the analysis-ready format into a single input sequence for the generative neural network model.

6. The system according to claim 1, wherein the circuitry is configured to compute the applicability score by extracting domain-specific features from each check item candidate using a learned text classifier, querying the storage device to retrieve condition data matching the target period and the category identifier, and comparing the extracted features against attributes of the retrieved condition data.

7. The system according to claim 6, wherein the condition data comprises at least audit standard information and regulation information, and the circuitry is configured to tag each check item candidate as applicable, partially applicable, or not applicable based on the applicability score relative to a stored threshold value.

8. The system according to claim 7, wherein the circuitry is configured to present the extracted check items to the terminal device with associated category labels and condition data references, receive from the terminal device at least one of an approval, a rejection, a wording correction, or a comment for each extracted check item, and store the received feedback as the feedback information.

9. The system according to claim 1, wherein the circuitry is configured to construct training data by pairing original context information with user-approved or user-corrected check item texts as target output sequences, compute a cross-entropy loss between predicted token distributions and the target output sequences, and perform backpropagation to update the parameters of the generative neural network model using an adaptive optimization algorithm.

10. The system according to claim 9, wherein the circuitry is configured to adjust at least one of a prompt template or a context generation rule based on aggregated statistics derived from the feedback information, the prompt template specifying a structure for combining the user-provided prompt string with features derived from the analysis-ready format.

11. The system according to claim 1, wherein the circuitry is configured to estimate the emotional state by applying the emotion identification model to at least one of text input, voice input, or image data received from the terminal device, classify the estimated emotional state into one of a plurality of emotional categories, and select an advice generation parameter for the generative neural network model based on the classified emotional category.

12. The system according to claim 11, wherein the circuitry is configured to generate the advice content by constructing a prompt sentence comprising the estimated emotional state and a task context associated with a current processing stage, and inputting the prompt sentence to the generative neural network model to produce natural-language guidance adapted in tone and detail level to the classified emotional category.

13. The system according to claim 12, wherein the circuitry is configured to adjust a presentation format of the extracted check items based on the classified emotional category, such that when the estimated emotional state indicates stress, the circuitry reduces a number of simultaneously displayed check items and increases emphasis on priority items.

14. The system according to claim 1, wherein the circuitry is configured to record a generation history comprising input context information, generated check item candidates, applicability scores, and the feedback information in the storage device as reusable reference data, and retrieve records from the generation history to augment the context information in subsequent processing cycles.

15. The system according to claim 14, wherein the circuitry is configured to monitor condition data retrieved from an external information source via the communication interface, detect a change in the condition data relative to previously stored condition data, regenerate affected check item candidates using the generative neural network model, and recompute applicability scores for the regenerated candidates.

16. The system according to claim 15, wherein the circuitry is configured to manage version differences between check items generated before and after the detected change by storing a difference record associating prior candidate identifiers with updated candidate identifiers and respective applicability scores.

17. The system according to claim 1, wherein the circuitry is configured to determine a timing condition for transmitting a notification to the terminal device based on a progress state of tasks associated with the extracted check items, and transmit the notification via the communication interface when the progress state satisfies the timing condition.

18. A system comprising:
circuitry configured to:
receive, via a communication interface coupled to a packet-switched network, structured performance data from a terminal device;
verify a structure and format of the structured performance data by checking field presence, data type conformance, and value range constraints, detect missing values and flag non-imputable records, and convert validated records into an analysis-ready format by normalizing numerical values and aligning categorical codes using a reference mapping table;
construct context information by aggregating features from the analysis-ready format into a textual summary comprising a target period indicator, a category identifier, and an anomaly tendency indicator, tokenizing a user-provided prompt string, and concatenating the tokenized prompt string with the textual summary;
generate, using a transformer-based generative neural network model and the context information, a plurality of check item candidates in natural language by executing forward passes over the context information and decoding output token sequences;
score each check item candidate against condition data stored in a storage device using a learned text classifier to compute an applicability score, tag each candidate as applicable, partially applicable, or not applicable, and transmit applicable check items to the terminal device;
receive feedback information from the terminal device comprising user corrections and evaluation data, construct training data pairing the context information with user-approved outputs, and fine-tune the generative neural network model using backpropagation with an adaptive optimization algorithm; and
estimate an emotional state of a user by applying an emotion identification model to input signals from the terminal device, classify the emotional state, and generate advice content adapted to the classified emotional state using the generative neural network model.

19. The system according to claim 18, wherein the circuitry is configured to adjust at least one generation parameter of the transformer-based generative neural network model based on the classified emotional state, the generation parameter comprising at least one of a sampling temperature or a maximum output length.

20. A method comprising:
receiving, via a communication interface coupled to a packet-switched network, structured performance data from a terminal device, the structured performance data representing operational conditions of an organization;
verifying a structure and format of the structured performance data, detecting missing values and inconsistencies, and converting the structured performance data into an analysis-ready format;
constructing context information for input to a generative neural network model by aggregating features derived from the analysis-ready format, the context information comprising at least a target period indicator, a category identifier, and an anomaly tendency indicator;
generating, using the generative neural network model and the context information, a plurality of check item candidates in natural language;
scoring each check item candidate against condition data stored in a storage device to compute an applicability score, and extracting check items for which the applicability score satisfies a threshold;
transmitting the extracted check items to the terminal device via the communication interface;
receiving feedback information from the terminal device comprising user-provided corrections and evaluation data with respect to the extracted check items, and updating parameters of the generative neural network model using training data constructed from the feedback information and the context information; and
estimating an emotional state of a user based on input signals received from the terminal device, and generating advice content adapted to the estimated emotional state using the generative neural network model.
